(19) United States
(12) Patent Application Publication
(10) Pub. No.: US 2024/0322990 A1
(43) Pub. Date: Sep. 26, 2024

(54) COMMUNICATION METHOD, APPARATUS AND SYSTEM

(71) Applicant: FUJITSU LIMITED, Kawasaki-shi Kanagawa (JP)

(72) Inventors: Lei ZHANG, Beijing (CN); Qinyan JIANG, Beijing (CN); Zhe CHEN, Beijing (CN); Xin WANG, Beijing (CN)

(73) Assignee: FUJITSU LIMITED, Kawasaki-shi Kanagawa (JP)

(21) Appl. No.: 18/672,142

(22) Filed: May 23, 2024

Related U.S. Application Data
(63) Continuation of application No. PCT/CN2021/133298, filed on Nov. 25, 2021.

(51) Int. Cl. H04L 5/14

(52) U.S. Cl. CPC H04L 5/14

(57) ABSTRACT

A communication apparatus, configured in a repeater, includes: a receiver configured to receive first indication information from a network device, the first indication information being used to indicate a time division duplex (TDD) uplink and downlink configuration, the TDD uplink and downlink configuration at least indicating a group of time units, the group of time units including one of the following: a downlink time unit; a downlink time unit and a flexible time unit; a downlink time unit, a flexible time unit and an uplink time unit; a flexible time unit and an uplink time unit; and an uplink time unit.

### CROSS-REFERENCE TO RELATED APPLICATION

This application is a continuation application of International Application PCT/CN2021/133298 filed on Nov. 25, 2021, and designated the U.S., the entire contents of which are incorporated herein by reference.

### TECHNICAL FIELD

The present disclosure relates to the field of communications.

### BACKGROUND

Compared with traditional 3G (third generation mobile communication technology) and 4G (fourth generation mobile communication technology) systems, a 5G (fifth generation mobile communication technology) system can provide a greater bandwidth and a higher data rate, and can support more types of terminals and vertical industry services. To this end, existing deployment frequencies for the 5G system are typically higher than those for 3G and 4G systems. For example, the 5G system can be deployed at a millimeter wave band.

However, the higher a carrying frequency, the more severe the fading that a signal experiences during transmission. Therefore, in actual deployment of the 5G system, especially at a millimeter wave band, how to better enhance cell coverage becomes an urgent problem to be solved.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

In order to better solve the coverage problem of a cellular mobile communication system in actual deployment, an RF repeater (RF relay/repeater) is adopted to amplify and forward a communication signal between a terminal equipment and a network device, and is a more commonly used deployment means. An RF repeater is widely applied in the actual deployment of 3G and 4G systems. Generally speaking, an RF repeater is a device that amplifies and forwards incoming and outgoing signals between a network device and a terminal equipment in an RF domain.

The RF repeater may be deployed in a TDD (time division duplex) network. In the deployment of 3G and 4G systems, once a frame structure of the TDD network is planned, it will remain unchanged for a long period of time. A traditional RF repeater does not have a function of communicating with a network device and cannot obtain any auxiliary information from the network device. Once it is deployed in the TDD network, it needs to detect and estimate a frame structure of the network by itself, that is, transmission time of uplink and downlink signals, and then forwards the uplink and downlink signals according to its estimation result.

In the 5G system, in order to support more and more flexible application scenarios, a frame structure/slot structure of the 5G system may be configured more flexibly, even different users in the same cell can use different frame structures/slot structures to communicate with the same network device.

The inventor finds that for the coverage problem encountered in the deployment of the 5G system, adopting an RF repeater to perform coverage enhancement is one of the feasible solutions. However, a traditional RF repeater cannot adapt well to a flexible deployment scenario of the 5G system through a method of obtaining transmission time of uplink and downlink signals by self-detection. Any wrong estimation of the transmission time of the uplink and downlink signals by the repeater may lead to incorrect forwarding of necessary signals and incorrect amplification of unnecessary signals resulting in additional interference, thereby reducing a received signal-to-noise ratio of a signal and resulting in decrease of the throughput of a whole network. For example, the repeater mistakenly estimates transmission time of an uplink signal as transmission time of a downlink signal, and switches to a downlink signal forwarding link at that time, resulting in that the uplink signal is not forwarded correctly, and the noise and interference in a direction of the downlink signal are amplified by the repeater.

In order to solve the above problem, the embodiments of the present disclosure provide a communication method, apparatus and system, so that the repeater can better realize a function of forwarding a signal under an indication of a network device. In addition, in order to obtain the indication from the network device, the repeater needs to have a function of communicating (or exchanging information) with the network device. The method provided in the embodiments of the present disclosure may further enable the repeater to communicate with the network device while forwarding, so as to receive an indication from the network device and better realize the function of forwarding a signal.

According to an aspect of the embodiments of the present disclosure, a communication apparatus is provided, configured in a repeater, wherein the apparatus comprises:
a communication unit configured to receive first indication information from a network device, the first indication information being used to indicate a time division duplex (TDD) uplink and downlink configuration, the TDD uplink and downlink configuration at least indicating a group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

According to another aspect of the embodiments of the present disclosure, a communication apparatus is provided, configured in a network device, wherein the apparatus comprises:
a transmitting unit configured to transmit first indication information to a repeater, the first indication information being used to indicate time division duplex (TDD) uplink and downlink configuration, the TDD uplink and downlink configuration indicating at least one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

One of the advantageous effects of the embodiments of the present disclosure lies in: according to the embodiments of the present disclosure, a network device transmits first indication information to a repeater, indicating an uplink time unit which is at least used to forward a first signal by the repeater to the network device, and/or indicating that a downlink time unit which is at least used to receive, by the repeater, a second signal from the network device, thereby the repeater can use indication information from the network device to better achieve a function of forwarding a signal, so as to better help the network device to communicate with a third device (such as a terminal equipment), i.e., to enhance the network coverage.

Referring to the later description and drawings, specific implementations of the present disclosure are disclosed in detail, indicating a manner that the principle of the present disclosure can be adopted. It should be understood that the implementations of the present disclosure are not limited in terms of the scope. Within the scope of the spirit and terms of the appended claims, the implementations of the present disclosure include many changes, modifications and equivalents.

Features that are described and/or illustrated with respect to one implementation may be used in the same way or in a similar way in one or more other implementations and in combination with or instead of the features in the other implementations.

It should be emphasized that the term “comprise/include” when being used herein refers to the presence of a feature, a whole piece, a step or a component, but does not exclude the presence or addition of one or more other features, whole pieces, steps or components.

### BRIEF DESCRIPTION OF DRAWINGS

An element and a feature described in a drawing or an implementation of the present embodiments of the present disclosure can be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art can also obtain other drawings based on these drawings under the premise that they do not pay inventive labor. In the drawings:

FIG. 1 is a schematic diagram of an application scenario of the embodiments of the present disclosure;

FIG. 2 is a schematic diagram of a communication method in the embodiments of a first aspect of the present disclosure;

FIG. 3 is a schematic diagram of a communication method in the embodiments of a second aspect of the present disclosure;

FIG. 4 is a schematic diagram of a communication apparatus in the embodiments of a third aspect of the present disclosure;

FIG. 5 is a schematic diagram of a communication apparatus in the embodiments of a fourth aspect of the present disclosure;

FIG. 6 is a schematic diagram of a repeater in the embodiments of the present disclosure;

FIG. 7 is a schematic diagram of a network device in the embodiments of the present disclosure.

### DETAILED DESCRIPTION

Referring to the drawings, through the following Specification, the aforementioned and other features of the present disclosure will become obvious. The Specification and the figures specifically disclose particular implementations of the present disclosure, showing partial implementations which can adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP) node, a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further includes a Remote Radio Head (RRH), a Remote Radio Unit (RRU), a relay or a low power node (such as femto, pico, etc.). And the term “base station” may include some or all functions of base station, each base station may provide communication coverage to a specific geographic region. The term “a cell” may refer to a base station and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

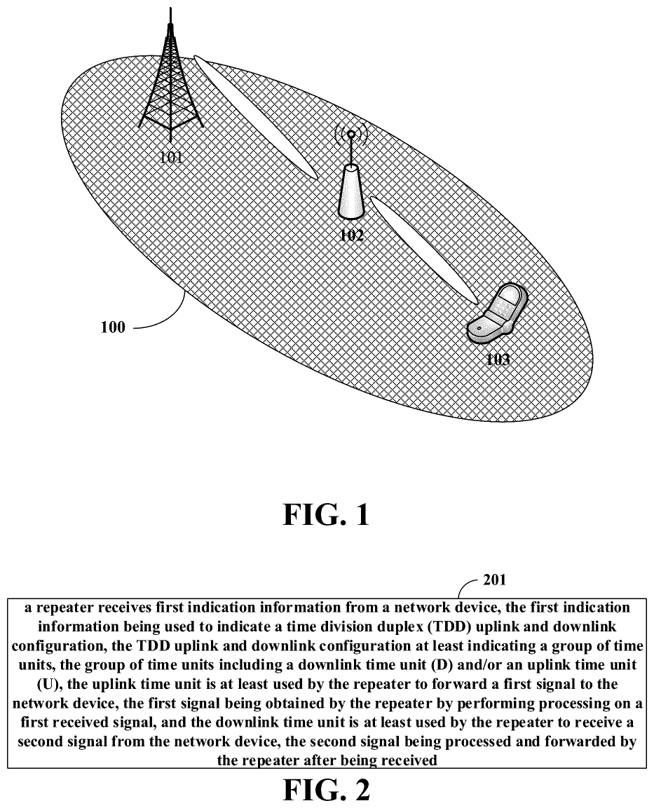

FIG. 1 is a schematic diagram of an application scenario of the embodiments of the present disclosure, as shown in FIG. 1, for convenience of description, description is made by taking “a network device (gNB) 101, a repeater 102 and a terminal equipment (UE) 103 communicate within a range of a cell or carrier 100” as an example, the present disclosure is not limited to this.

In the embodiments of the present disclosure, transmission of existing or further implementable services can be carried out between the network device 101 and the terminal equipment 103. For example, these services may include but be not limited to: enhanced Mobile Broadband (eMBB), massive Machine Type Communication (mMTC), Ultra-Reliable Low-Latency Communication (URLLC), Internet of Vehicles (V2X) communication and so on.

In the process of research in related fields, the inventor finds that communication between a repeater and a network device needs generation of a signal transmitted to the network device, or needs processing of the signal transmitted by the network device. The inventor considers that how to multiplex forwarding and communication functions of a repeater together is a key point to realize a repeater having a communication function, and also is an urgent problem to be solved.

Various implementations of the embodiments of the present disclosure will be described below with reference to the drawings. These implementations are exemplary only and are not limitations to the present disclosure.

### Embodiments of a First Aspect

The embodiments of the present disclosure provide a communication method, which is described from a side of a repeater device.

FIG. 2 is a schematic diagram of a communication method in the embodiments of the present disclosure, referring to FIG. 2, the method comprises:
201: a repeater receives first indication information from a network device, the first indication information being used to indicate a time division duplex (TDD) uplink and downlink configuration (tdd-UL-DL-Configuration), the TDD uplink and downlink configuration at least indicating a group of time units, the group of time units including one of the following:
a downlink time unit (D);
a downlink time unit (D) and a flexible time unit (F);
a downlink time unit (D), a flexible time unit (F) and an uplink time unit (U);
a flexible time unit (F) and an uplink time unit (U); and
an uplink time unit (U);
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

In the embodiments of the present disclosure, the first signal is not generated by the repeater. The first received signal used to obtain the first signal is from a third device. In addition, after processing the second signal, the repeater forwards the processed signal. The third device or another device receives the forwarded processed signal.

According to the embodiments of the present disclosure, a network device indicates a repeater about an uplink time unit and a downlink time unit in a TDD uplink and downlink configuration through first indication information. The uplink time unit is used at least by the repeater to forward a first signal to the network device, and the downlink time unit is used at least by the repeater to receive a second signal from the network device. Thereby, the repeater can use indication information from the network device to better achieve a function of forwarding a signal, so as to better help the network device to communicate with a terminal equipment (for example, the third device), i.e., to enhance the network coverage.

In some embodiments, first indication information is further used to configure a period of said group of time units and/or a subcarrier interval corresponding to said group of time units.

In some embodiments, first indication information may be an RRC (Radio Resource Control) signaling and/or a MAC (Media Access Control) signaling and/or physical layer control information, but the present disclosure is not limited to this.

In the above embodiments, the first indication information at least comprises one or more of the following signalings: a high-layer signaling containing tdd-UL-DL-ConfigurationCommon; a high-layer signaling containing tdd-UL-DL-ConfiguratingDedicated, a physical control channel DCI format 2_0, and a physical control channel DCI format 2_5.

For example, the first indication information is a high-layer signaling containing tdd-UL-DL-ConfigurationCommon.

For example, the first indication information is a high-layer signaling containing tdd-UL-DL-ConfigurationCommon and a high-layer signaling containing tdd-UL-DL-ConfiguratingDedicated.

For another example, the first indication information is a high-layer signaling containing tdd-UL-DL-ConfigurationCommon, a high-layer signaling containing tdd-UL-DL-ConfiguratingDedicated and a physical control channel DCI format 2_0.

For another example, the first indication information is a high-layer signaling containing tdd-UL-DL-ConfiguratingDedicated and a physical control channel DCI format 2_0.

In the embodiments of the present disclosure, a time unit (i.e., U or D or F) in said group of time units may be a symbol, or may be a slot, or may be a combination of a symbol and a slot, the present disclosure does not make limitations in this regard.

For example, the uplink time unit U is a symbol and/or slot, the downlink time unit D is a symbol and/or slot, while the flexible time unit F is a symbol.

For another example, the uplink time unit U is a symbol and/or slot, the downlink time unit D is a symbol and/or slot, while the flexible time unit F is a slot.

For another example, the uplink time unit U is a symbol and/or slot, the downlink time unit D is a symbol and/or slot, while the flexible time unit F is a combination of a symbol and a slot.

In the embodiments of the present disclosure, a repeater may further process a received signal before forwarding the received signal.

For example, the repeater obtains a first signal by processing the first received signal, the processing here may include amplification processing on the first received signal by the repeater, but the present disclosure is not limited to this, and the processing here may further include other processing.

For another example, after receiving a second signal from a network device, the repeater may process the second signal and then forward it, the processing here may include amplification processing on the second signal by the repeater, but the present disclosure is not limited to this, and the processing here may further include other processing.

In the embodiments of the present disclosure, the repeater forwards a received signal, which may include that the repeater does not demodulate and decode the received signal, but only performs the above-mentioned processing (such as amplification processing) on the received signal.

For example, the repeater forwards the first signal, which includes: the repeater does not demodulate or decode the aforementioned first received signal, but only performs the aforementioned processing (such as amplification processing) on the first received signal to obtain the first signal, and transmits the first signal (such as the first received signal after amplification) to a network device.

For another example, the repeater forwards the processed second signal, which includes: the repeater does not demodulate and decode the received second signal, but only transmits the processed second signal after performing the above-mentioned processing (such as amplification processing) on the received second signal.

In the embodiments of the present disclosure, in order to obtain the indication from the network device, the repeater needs to have a function of communicating (or exchanging information) with the network device. The repeater may further transmit an uplink signal to the network device or receive a downlink signal from the network device according to an indication of the network device, that is, perform uplink communication or downlink communication with the network device.

In some embodiments, a repeater may further receive second indication information from a network device, the second indication information being used to indicate that a second time unit is used by the repeater to transmit an uplink signal generated by the repeater to the network device, the second time unit being an uplink time unit and/or a flexible time unit in the TDD uplink and downlink configuration. Or, the second indication information is used to redefine/override a second time unit in the TDD uplink and downlink configuration as a time unit which is used by the repeater to transmit an uplink signal generated by the repeater to the network device. That is, the network device indicates, via second indication information, at least part of an uplink time unit and/or a flexible time unit in the TDD uplink and downlink configuration as a second time unit used by a repeater to perform uplink communication. The second time unit is not used by the repeater to perform uplink forwarding, but the present disclosure is not limited to this, the second time unit may also be used by the repeater to perform uplink forwarding. In addition, an uplink time unit that is not redefined by the second indication information is only used by the repeater to perform uplink forwarding, not used by the repeater to perform uplink communication (i.e., transmitting an uplink signal generated by the repeater).

In the above embodiments, the number of second time units may be one or greater than one, and in the case of being greater than one, the greater than one second time unit may be continuous or may also be discontinuous.

In the above embodiments, in a case where the group of time units in the TDD uplink and downlink configuration is periodic, the second indication information is further used to indicate that a second time unit in each period or a specified period of the group of time units in the TDD uplink and downlink configuration is used by the repeater to transmit an uplink signal generated by the repeater to the network device. That is, the network device indicates, through the above second indication information, that a second time unit in each period or a specified period of a group of time units is used by the repeater to perform uplink communication, until a new instruction re-indicates a purpose of the second time unit.

In the above embodiments, the second indication information may be a PDCCH, or may be a high-layer signaling. Here, the PDCCH may be a common PDCCH, or may be dedicated signaling. Here, the common PDCCH e.g. is PDCCH format 2_0 or PDCCH format 2_x, the present disclosure does not limit a value of x. Here, the high-layer signaling may be common, or may be dedicated. For example, the second indication information is a common PDCCH. For another example, the second indication information is a dedicated high-layer signaling.

In the above embodiments, the second time unit is not used by the repeater to perform uplink forwarding, i.e., the second time unit is not used by the repeater to forward said first signal to a network device; or, the second time unit is not used by the repeater to receive said first received signal which is used to obtain the first signal, i.e., the repeater does not receive the first received signal which is used to obtain the first signal in a time unit (a second time unit) configured for the repeater to perform uplink communication. However, as described above, the present disclosure is not limited to this, the second time unit may also be used by the repeater to perform uplink forwarding.

In some embodiments, a repeater may further receive third indication information from a network device, the third indication information being used to indicate the repeater to transmit, at a third time unit, a third signal generated by the repeater, the third time unit being a flexible time unit and/or an uplink time unit in the TDD uplink and downlink configuration. Different from the second indication information indicating a second time unit for uplink communication, the present embodiment implicitly indicates a time unit for uplink communication through third indication information indicating at which time units (a third time unit) a repeater performs uplink communication (i.e., transmits a third signal) and by indicating the repeater to transmit the third signal at the third time unit. The third time unit is not used by the repeater to perform uplink forwarding, but the present disclosure is not limited to this, the third time unit may also be used by the repeater to perform uplink forwarding. In addition, an uplink time unit that is not indicated by the third indication information is only used by the repeater to perform uplink forwarding, not used by the repeater to perform uplink communication (i.e., transmitting an uplink signal generated by the repeater).

In the above embodiments, the third time unit is one or more than one time unit, or one or more than one time unit that is periodic.

In the above embodiments, in a case where the third time unit is one or more than one time unit, the third indication information may be a PDCCH, and the third signal may be at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

In the above embodiments, in a case where the third time unit is one time unit in one period, the third indication information may be a high-layer signaling, and the third signal may be at least one of the following: a PRACH, a PUCCH, a Demodulation Reference Signal (DMRS). The present disclosure does not limit the high-layer signaling, it may be a MAC signaling, or may be an RRC signaling, etc., the present disclosure is not limited to this.

In the above embodiments, in a case where the third time unit is one or more than one time unit that is periodic, the third indication information may be a high-layer signaling, and the third signal may be a Configuration Grant (CG) PUSCH and/or an SRS. The high-layer signaling e.g. may be a MAC signaling or an RRC signaling, etc.

In the above embodiments, the third signal (i.e., uplink communication between a repeater and a network device) may carry channel state information, the channel state information here may be obtained by one or more of the following measurements:
SRS-based measurement according to a configuration of the network device;
Channel State Information Reference Signal (CSI-RS)-based measurement according to a configuration of the network device;
Synchronization Signal Block (SSB)-based measurement according to a configuration of the network device;
Positioning Reference Signal (PRS)-based measurement according to a configuration of the network device; and
Cross Link Interference Reference Signal (CLI-RS)-based measurement according to a configuration of the network device.

In the above embodiments, the repeater may, based on the above configuration of the network device, report the channel state information obtained according to a corresponding measurement to the network device through a third signal. The present disclosure does not limit a measurement method, relevant technologies may be referred to.

In the above embodiments, the third signal may be a Random Access Channel (RACH), and the third indication information may be at least one of the following: system information, high-layer control information and a PDCCH. That is, the network device may indicate a repeater of a time unit (a third time unit) used to transmit a RACH via system information, high-layer control information and/or a PDCCH. And, the repeater may transmit the RACH to the network device at the third time unit according to an indication of the network device. The RACH is used for the purposes of performing random access, resource request, RRC reestablishment, etc. by the repeater, the present disclosure is not limited to this.

In the above embodiments, the third time unit is not used by the repeater to perform uplink forwarding, i.e., the third time unit is not used by the repeater to forward said first signal to a network device; or, the third time unit is not used by the repeater to receive said first received signal which is used to obtain the first signal, i.e., the repeater does not receive the first received signal which is used to obtain the first signal in a time unit (a third time unit) configured for the repeater to perform uplink communication. However, as described above, the present disclosure is not limited to this, the third time unit may also be used by the repeater to perform uplink forwarding.

In the above embodiments, the repeater may further generate a signal (e.g., a third signal) for being transmitted to a network device based on information of the network device (e.g., third indication information), the signal (e.g., the third signal) for being transmitted to the network device is used to carry information and/or data (e.g., the aforementioned channel state information) transmitted by the repeater to the network device, and/or is used by the network device to perform measurement and/or estimating on a channel and/or a signal from the repeater to the network device. The present disclosure does not limit a specific measurement and/or estimation method, relevant technologies may be referred to.

According to the above embodiments, in an implementation method, a repeater may perform uplink communication and uplink forwarding at different times. For example, a second time unit and/or a third time unit are not used by the repeater to perform uplink forwarding. A network device indicates a time unit other than the second time unit and/or the third time unit to be used by the repeater to perform uplink forwarding. Thereby, uplink communication and uplink forwarding are time division multiplexed. This implementation method has lower requirements on a device and is helpful to reduce the implementation cost of a repeater. The implementation cost reduction is conducive to future application of a repeater device in network deployment, and is also conducive to enhancing network deployment at a lower cost (such as improving network coverage).

In another implementation method, a repeater may perform uplink communication in a time unit, and may also perform uplink forwarding in this time unit. For example, a second time unit and/or a third time unit are used by the repeater to perform uplink forwarding. Through this implementation method, a network device may indicate a repeater to perform uplink forwarding in any uplink and/or flexible time unit, which is conducive to ensuring the forwarding efficiency, thereby improving the efficiency of spectrum use.

In the embodiments of the present disclosure, the downlink time unit D in the TDD uplink and downlink configuration may be further used by the repeater to receive a downlink signal transmitted to itself from the network device. That is, in some embodiments, in the same time unit, the repeater may perform downlink forwarding (i.e., the repeater receives a signal from the network device, processes the signal and then forwards it out), and may further perform downlink communication (i.e., the repeater receives a signal from the network device and obtains the signal transmitted to itself).

In some other embodiments, a repeater may further receive fourth indication information from a network device, the fourth indication information being used to indicate that a fourth time unit is used by the repeater to receive a downlink signal transmitted by the network device to the repeater, the fourth time unit being a downlink time unit and/or a flexible time unit in the TDD uplink and downlink configuration. Or, the fourth indication information is used to redefine/override a fourth time unit in the TDD uplink and downlink configuration as a time unit used by the repeater to receive a downlink signal transmitted by the network device to the repeater. That is, the network device indicates, via fourth indication information, at least part of a downlink time unit and/or a flexible time unit in the TDD uplink and downlink configuration as a fourth time unit for a repeater to perform downlink communication. The fourth time unit is not used by the repeater to perform downlink forwarding, but the present disclosure is not limited to this, the fourth time unit may also be used by the repeater to perform downlink forwarding. In addition, a downlink time unit that is not redefined by the fourth indication information is only used by the repeater to perform downlink forwarding, not for the repeater to perform downlink communication (i.e., receiving a downlink signal transmitted by a network device to itself).

In the above embodiments, the number of fourth time units may be one or greater than one, and in the case of being greater than one, the greater than one fourth time unit may be continuous or may also be discontinuous.

In the above embodiments, in a case where the group of time units in the TDD uplink and downlink configuration is periodic, the fourth indication information is further used to indicate that a fourth time unit in each period or a specified period of the group of time units in the TDD uplink and downlink configuration is used by the repeater to receive a downlink signal transmitted by the network device to the repeater. That is, the network device indicates, through the above fourth indication information, that a fourth time unit in each period or a specified period of a group of time units is used for the repeater to perform downlink communication, until a new instruction re-indicates a purpose of the fourth time unit.

In the above embodiments, the fourth indication information may be a PDCCH, or may be a high-layer signaling. Here, the PDCCH may be a common PDCCH, or may be dedicated signaling. Here, the common PDCCH e.g. is PDCCH format 2_0 or PDCCH format 2_x, the present disclosure does not limit a value of x. Here, the high-layer signaling may be common, or may be dedicated. For example, the fourth indication information is a common PDCCH. For another example, the fourth indication information is a dedicated high-layer signaling.

In the above embodiments, the fourth indication information and the second indication information may be carried by the same signaling, i.e., a second time unit and a fourth time unit are indicated via one signaling. Relevant contents about the second time unit and the fourth time unit have been described in the preceding text, and are not repeated here.

For example, the fourth indication information is further used to indicate that a second time unit is used by a repeater to transmit an uplink signal generated by the repeater to the network device, the second time unit being an uplink time unit and/or a flexible time unit in the TDD uplink and downlink configuration. That is, the network device may simultaneously indicate the second time unit and the fourth time unit through the fourth indication information, for example, indicate an uplink time unit and/or a flexible time unit in the TDD uplink and downlink configuration as a second time unit used by the repeater to perform uplink communication, and indicate a downlink time unit and/or a flexible time unit in the TDD uplink and downlink configuration as a fourth time unit used by the repeater to perform downlink communication.

For another example, the first indication information is a high-layer signaling containing tdd-UL-DL-ConfigurationCommon for indicating a TDD uplink and downlink configuration, the fourth indication information is a high-layer signaling containing tdd-UL-DL-ConfiguratingDedicated for indicating said second time unit and said fourth time unit.

For another example, the first indication information is a high-layer signaling containing tdd-UL-DL-ConfigurationCommon for indicating a TDD uplink and downlink configuration, the fourth indication information is a high-layer signaling containing tdd-UL-DL-ConfiguratingDedicated and/or a physical control channel DCI format 2_x (or DCI format 2_0) for indicating said second time unit and said fourth time unit.

For another example, the first indication information is a high-layer signaling containing tdd-UL-DL-ConfigurationCommon and/or a high-layer signaling containing tdd-UL-DL-ConfiguratingDedicated for indicating a TDD uplink and downlink configuration, the fourth indication information is a physical control channel DCI format 2_x (or DCI format 2_0) for indicating said second time unit and said fourth time unit.

In the above embodiments, the first indication information and the fourth indication information may be carried by the same signaling, i.e., a TDD uplink and downlink configuration and a fourth time unit are indicated via one signaling, or a TDD uplink and downlink configuration, a second time unit and a fourth time unit are indicated via one signaling.

For example, a high-layer signaling containing tdd-UL-DL-ConfiguratingDedicated is used to indicate said TDD uplink and downlink configuration, said second time unit and said fourth time unit.

For another example, a new high-layer signaling (e.g. containing SR bytes) introduced to the standard for supporting a repeater is used to indicate said TDD uplink and downlink configuration, said second time unit and said fourth time unit.

Relevant contents about the TDD uplink and downlink configuration, the second time unit and the fourth time unit have been described in the preceding text, and are not repeated here.

In some embodiments, a repeater may further receive fifth indication information from a network device, the fifth indication information being used to indicate the repeater to receive a fifth signal from the network device at a fifth time unit, the fifth time unit being a flexible time unit and/or a downlink time unit in the TDD uplink and downlink configuration. Different from the fourth indication information indicating a fourth time unit for downlink communication, the present embodiment implicitly indicates a time unit for downlink communication through fifth indication information indicating at which time units (a fifth time unit) a repeater performs downlink communication (i.e., receives a fifth signal) and by indicating the repeater to receive the fifth signal at the fifth time unit. The fifth time unit is not used by the repeater to perform downlink forwarding, but the present disclosure is not limited to this, the fifth time unit may also be used by the repeater to perform downlink forwarding. In addition, a downlink time unit that is not indicated by the fifth indication information is only used by the repeater to perform downlink forwarding, not used by the repeater to perform downlink communication (i.e., receiving a downlink signal transmitted by a network device to the repeater).

In the above embodiments, the fifth signal is used by the repeater to perform demodulating and decoding to obtain information and/or data transmitted by the network device to itself, and/or to estimate and/or measure a channel and/or signal from the repeater to the network device.

In the above embodiments, the fifth time unit is one or more than one time unit, or one or more than one time unit that is periodic.

In the above embodiments, in a case where the fifth time unit is one or more than one time unit, the fifth indication information may be a PDCCH, and the fifth signal may be at least one of the following: a PDSCH, a Phase Tracking Reference Signal (PTRS), a CSI-RS, an SSB, an SIB, an activated semi-static PDSCH (SPS-PDSCH).

In the above embodiments, in a case where the fifth time unit is one or more than one time unit that is periodic, the fifth indication information may be a high-layer signaling, and the fifth signal may be at least one of the following: a PDCCH, a Time Reference Signal (TRS), an SSB, an SIB, a CSI-RS, a semi-static PDSCH (SPS-PDSCH).

In the above embodiments, the fifth signal may be an SIB, and the fifth indication information may be an SSB and/or a high-layer signaling, the present disclosure is not limited to this.

In the above embodiments, the fifth signal (i.e., downlink communication between the repeater and the network device) may carry indication information in which the network device indicates a spatial filter to the repeater, the indication information here may include at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

In the above embodiments, the transmitting spatial filter for the repeater to forward the first signal to the network device may be the same as the transmitting spatial filter for the repeater to transmit the third signal to the network device, but the present disclosure is not limited to this. In addition, the receiving spatial filter for the repeater to receive the second signal may be the same as the receiving spatial filter for the repeater to receive the fourth signal from the network device, but the present disclosure is not limited to this.

According to the above embodiments, in an implementation method, a repeater may perform downlink communication and downlink forwarding at different times. For example, a fourth time unit and/or a fifth time unit are not used by the repeater to perform downlink forwarding. A network device indicates a time unit other than the fourth time unit and/or the fifth time unit to be used by the repeater to perform downlink forwarding. Thereby, the downlink communication and the downlink forwarding are time division multiplexed, which is helpful to simplify management of wireless resources by a network device, thereby to reduce the implementation cost of network device. In addition, it can also simplify an implementation logic of a repeater and reduce the cost of the repeater.

In another implementation method, a repeater may perform downlink communication at a time unit, and may also perform downlink forwarding at this time unit. For example, a fourth time unit and/or a fifth time unit may also be used by the repeater to perform downlink forwarding. This implementation method does not require high device implementation, and helps to reduce indication signaling of a network device, improve the use efficiency of a wireless resource, thereby to improve a network throughput.

In some embodiments, the repeater does not transmit the uplink signal generated by the repeater to the network device at the uplink time unit in the TDD uplink and downlink configuration. For example, the repeater transmits an uplink signal/third signal generated by the repeater to the network device in the aforementioned second time unit and/or third time unit, the aforementioned second time unit is a flexible time unit in the TDD uplink and downlink configuration, and/or the aforementioned third time unit is a flexible time unit in the TDD uplink and downlink configuration.

In some embodiments, the repeater does not transmit an uplink signal generated by the repeater to the network device at the uplink time unit in the TDD uplink and downlink configuration; and the repeater does not receive a downlink signal transmitted by the network device to the repeater in the downlink time unit in the TDD uplink and downlink configuration. For example, the repeater transmits an uplink signal/third signal generated by the repeater to the network device in the aforementioned second time unit and/or third time unit, the aforementioned second time unit is a flexible time unit in the TDD uplink and downlink configuration, and/or the aforementioned third time unit is a flexible time unit in the TDD uplink and downlink configuration. For another example, the repeater receives a downlink signal/fifth signal transmitted by the network device to itself in the aforementioned fourth time unit and/or fifth time unit, the aforementioned fourth time unit is a flexible time unit in the TDD uplink and downlink configuration, and/or the aforementioned fifth time unit is a flexible time unit in the TDD uplink and downlink configuration.

According to the above embodiments, by indicating a repeater to use a flexible time unit to communicate with a network device, which helps reduce influence on existing standards and accelerate a standardization process; and reduces the time to upgrade and develop a network device, and accelerates a speed of deploying a repeater in a network.

The above embodiments are only illustrative for the embodiments of the present disclosure, but the present disclosure is not limited to this, appropriate modifications can be also made based on the above embodiments. For example, the above embodiments may be used individually, or one or more of the above embodiments may be combined.

For example, a repeater receives the first indication information and confirms an TDD uplink and downlink configuration according to an indication, a downlink time unit in the TDD uplink and downlink configuration may be used by the repeater to perform both downlink forwarding and downlink communication.

In this example, the repeater further receives the above second indication information, and confirms a second time unit that may be used for uplink communication according to an indication; and/or the repeater receives the above third indication information, and confirms a third time unit used to transmit a third signal according to an indication.

In this example, the second time unit and/or the third time unit is/are not used by the repeater to perform uplink forwarding. And, the uplink time unit that is not indicated as a second time unit and/or is not indicated as a third time unit in the TDD uplink and downlink configuration is not used by the repeater to perform uplink communication, or, a time unit that is not indicated as a second time unit and/or is not indicated as a third time unit in the TDD uplink and downlink configuration is not used by the repeater to perform uplink communication.

For another example, the repeater receives the first indication information and confirms an TDD uplink and downlink configuration according to an indication, a downlink time unit in the TDD uplink and downlink configuration is only used by the repeater to perform downlink forwarding.

In this example, the repeater further receives the above second indication information, and confirms a second time unit that may be used for uplink communication according to an indication; and/or the repeater receives the above third indication information, and confirms a third time unit used to transmit a third signal according to an indication.

In this example, the second time unit and/or the third time unit is/are not used by the repeater to perform uplink forwarding. And, the uplink time unit that is not indicated as a second time unit and/or is not indicated as a third time unit in the TDD uplink and downlink configuration is not used by the repeater to perform uplink communication, or, a time unit that is not indicated as a second time unit and/or is not indicated as a third time unit in the TDD uplink and downlink configuration is not used by the repeater to perform uplink communication.

In this example, the repeater further receives the above fourth indication information, and confirms a fourth time unit that may be used for downlink communication according to an indication; and/or the repeater further receives the above fifth indication information, and confirms a fifth time unit used to transmit a fifth signal according to an indication.

In this example, the fourth time unit and/or the fifth time unit is/are not used by the repeater to perform downlink forwarding. And, the downlink time unit that is not indicated as a fourth time unit and/or is not indicated as a fifth time unit in the TDD uplink and downlink configuration is not used by the repeater to perform downlink communication, or, a time unit that is not indicated as a fourth time unit and/or is not indicated as a fifth time unit in the TDD uplink and downlink configuration is not used by the repeater to perform downlink communication.

For another example, a repeater receives the first indication information and confirms an TDD uplink and downlink configuration according to an indication, a downlink time unit in the TDD uplink and downlink configuration may be used by the repeater to perform both downlink forwarding and downlink communication.

In this example, the repeater further receives the above second indication information, and confirms a second time unit that may be used for uplink communication according to an indication; and/or the repeater receives the above third indication information, and confirms a third time unit used to transmit a third signal according to an indication.

In this example, the second time unit and/or the third time unit is/are not used by the repeater to perform uplink forwarding. And, the uplink time unit that is not indicated as a second time unit and/or is not indicated as a third time unit in the TDD uplink and downlink configuration is not used by the repeater to perform uplink communication, or, a time unit that is not indicated as a second time unit and/or is not indicated as a third time unit in the TDD uplink and downlink configuration is not used by the repeater to perform uplink communication.

In this example, the repeater further receives the above fourth indication information, and confirms a fourth time unit that may be used for downlink communication according to an indication; and/or the repeater further receives the above fifth indication information, and confirms a fifth time unit used to transmit a fifth signal according to an indication.

For another example, a repeater receives the first indication information and confirms an TDD uplink and downlink configuration according to an indication, a downlink time unit in the TDD uplink and downlink configuration may be used by the repeater to perform both downlink forwarding and downlink communication, and an uplink time unit in the TDD uplink and downlink configuration is only used by the repeater to perform uplink forwarding.

In this example, the repeater further receives the above second indication information, and confirms a second time unit that may be used for uplink communication according to an indication, the second time unit being a flexible time unit in the TDD uplink and downlink configuration; and/or the repeater receives the above third indication information, and confirms a third time unit used to transmit a third signal according to an indication, the third time unit being a flexible time unit in the TDD uplink and downlink configuration.

In this example, the second time unit and/or the third time unit is/are not used by the repeater to perform uplink forwarding. And, a time unit that is not indicated as a second time unit and/or is not indicated as a third time unit in the TDD uplink and downlink configuration is not used by the repeater to perform uplink communication.

For another example, a repeater receives the first indication information and confirms an TDD uplink and downlink configuration according to an indication, a downlink time unit in the TDD uplink and downlink configuration is only used by the repeater to perform downlink forwarding, and an uplink time unit in the TDD uplink and downlink configuration is only used by the repeater to perform uplink forwarding.

In this example, the repeater further receives the above second indication information, and confirms a second time unit that may be used for uplink communication according to an indication, the second time unit being a flexible time unit in the TDD uplink and downlink configuration; and/or the repeater receives the above third indication information, and confirms a third time unit used to transmit a third signal according to an indication, the third time unit being a flexible time unit in the TDD uplink and downlink configuration.

In this example, the second time unit and/or the third time unit is/are not used by the repeater to perform uplink forwarding. And, a time unit that is not indicated as a second time unit and/or is not indicated as a third time unit in the TDD uplink and downlink configuration is not used by the repeater to perform uplink communication.

In this example, the repeater further receives the above fourth indication information, and confirms a fourth time unit that may be used for downlink communication according to an indication, the fourth time unit being a flexible time unit in the TDD uplink and downlink configuration; and/or the repeater further receives the above fifth indication information, and confirms a fifth time unit used to receive a fifth signal according to an indication, the fifth time unit being a flexible time unit in the TDD uplink and downlink configuration.

In this example, a time unit that is not indicated as a fourth time unit and/or is not indicated as a fifth time unit in the TDD uplink and downlink configuration is not used by the repeater to perform downlink communication. And, the fourth time unit and/or the fifth time unit is/are not used by the repeater to perform uplink forwarding.

In the above example, the repeater is only indicated to use a flexible time unit to perform uplink or downlink communication with the network device, which helps reducing influence on existing standards and accelerating a standardization process; and reducing the time to upgrade and develop a network device, and accelerating a speed of deploying a repeater in a network.

In the embodiments of the present disclosure, a repeater may receive the first indication information from a network device in a first cell, and the repeater may forward the first signal to the network device in the first cell and/or receives the second signal from the network device in the first cell.

In the above embodiments, the first cell may be a serving cell of the repeater. However, the present disclosure is not limited to these.

In the above embodiments, the first cell may be a cell for the repeater to perform initial access; and/or, the first cell may be a cell where the repeater establishes an RRC connection with a network device; and/or, the first cell may be a cell where the repeater reestablishes an RRC connection with a network device; and/or, the first cell may be a cell where the repeater resides; and/or, the first cell may be a cell selected by the repeater through a cell process, or a cell re-selected through a cell re-selection process.

In the above embodiments, the first cell may be a primary cell of the repeater. However, the present disclosure is not limited to these.

The above embodiments are only illustrative for the embodiments of the present disclosure, but the present disclosure is not limited to this, appropriate modifications can be also made based on the above embodiments. For example, the above embodiments may be used individually, or one or more of the above embodiments may be combined.

The above only describes steps or processes related to the present disclosure, but the present disclosure is not limited to this. The method in the embodiments of the present disclosure may further comprise other steps or processes. For specific contents of these steps or processes, please refer to relevant technologies.

According to the method in the embodiments of the present disclosure, a network device indicates a repeater of the meaning of an uplink time unit and/or a downlink time unit in a TDD uplink and downlink configuration via first indication information, i.e., the uplink time unit is used at least by the repeater to forward a first signal to the network device, and the downlink time unit is used at least by the repeater to receive a second signal from the network device, thereby the repeater can use indication information from the network device to better achieve a function of forwarding a signal, so as to better help the network device to communicate with a third device (such as a terminal equipment), i.e., to enhance the network coverage.

### Embodiments of a Second Aspect

The embodiments of the present disclosure provide a communication method, which is described from a network device side. The method corresponds to the method in the embodiments of the first aspect, wherein the same contents as the embodiments of the first aspect are not repeated.

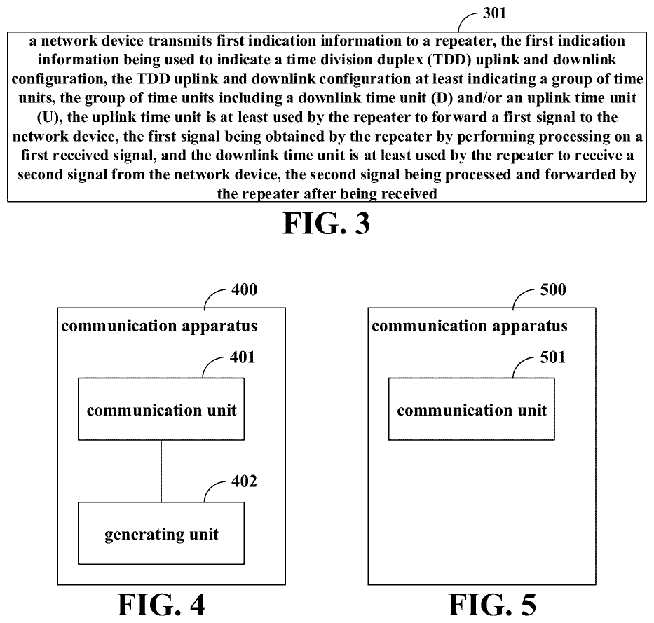

FIG. 3 is a schematic diagram of a communication method in the embodiments of the present disclosure, as shown in FIG. 3, the method comprises:
301: a network device transmits first indication information to a repeater, the first indication information being used to indicate time division duplex (TDD) uplink and downlink configuration, the TDD uplink and downlink configuration indicating at least one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

In some embodiments, the first indication information is at least further used to configure a period of the group of time units and/or a subcarrier interval corresponding to the group of time units.

In some embodiments, the first indication information is at least one of the following signalings or information:
Wireless Resource Control (RRC) signaling;
Media Access Control (MAC) signaling; and
physical layer control information.

In the above embodiments, the first indication information at least includes one or more of the following signalings:
a high-layer signaling containing tdd-UL-DL-ConfigurationCommon;
a high-layer signaling containing tdd-UL-DL-ConfiguratingDedicated;
a physical control channel DCI format 2_0, and
a physical control channel DCI format 2_5.

In some embodiments, the time unit is a symbol and/or slot.

For example, the uplink time unit is a symbol and/or slot, the downlink time unit is a symbol and/or slot, and the flexible time unit is a symbol and/or slot.

In some embodiments, the performing processing on the first received signal by the repeater comprises: at least performing amplification on the first received signal by the repeater; and the performing processing on the second signal by the repeater comprises: at least performing amplification on the second signal by the repeater.

In some embodiments, the uplink time unit is at least used by the repeater to forward the first signal to the network device in the following manner: not performing demodulating and decoding on the first received signal, performing only the processing on the first received signal to obtain the first signal, and transmitting the first signal to the network device; and the downlink time unit is at least used by the repeater to forward the processed second signal in the following manner: not performing demodulating and decoding on the received second signal, performing only the processing on the received second signal, and transmitting the processed second signal.

In some embodiments, the method further comprises:
the network device transmits second indication information to the repeater, the second indication information being used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some examples, the second indication information is used to indicate that the second time unit in each period of the group of time units of the TDD uplink and downlink configuration is used by the repeater to transmit the uplink signal generated by the repeater to the network device.

In the above embodiments, in some examples, the second indication information is a Physical Downlink Control Channel (PDCCH) or a high-layer signaling. The PDCCH, for example, is a common PDCCH. The high-layer signaling, for example, is dedicated signaling.

In the above embodiments, in some examples, the second time unit is not used by the repeater to forward the first signal to the network device, or the second time unit is not used by the repeater to receive the first received signal for obtaining the first signal.

In some embodiments, the method further comprises:
the network device transmits third indication information to the repeater, the third indication information being used to indicate the repeater to transmit a third signal generated by the repeater at a third time unit, the third time unit being the flexible time unit and/or the uplink time unit in the TDD uplink and downlink configuration.

In the above embodiments, in some examples, the third time unit is one or more than one time unit, or one or more than one time unit that is periodic.

In the above embodiments, in some examples, the third time unit is one or more than one time unit, the third indication information is a PDCCH, and the third signal is at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

In the above embodiments, in some examples, the third time unit is one time unit in one period, the third indication information is a high-layer signaling, and the third signal is at least one of the following: a PRACH, a PUCCH, a Demodulation Reference Signal (DMRS).

In the above embodiments, in some examples, the third time unit is one or more than one time unit that is periodic, the third indication information is a high-layer signaling, the third signal is a Configuration Grant (CG) PUSCH and/or an SRS, and the high-layer signaling is a MAC signaling or an RRC signaling.

In the above embodiments, in some examples, the third signal is used to carry channel state information, the channel state information being obtained via one or more of the following measurements:
SRS-based measurement according to a configuration of the network device;
Channel State Information Reference Signal (CSI-RS)-based measurement according to a configuration of the network device;
Synchronization Signal Block (SSB)-based measurement according to a configuration of the network device;
Positioning Reference Signal (PRS)-based measurement according to a configuration of the network device; and
Cross Link Interference Reference Signal (CLI-RS)-based measurement according to a configuration of the network device.

In the above embodiments, in some examples, the third signal is a Random Access Channel (RACH), and the third indication information is at least one of the following: system information, high-layer control information and a PDCCH.

In the above embodiments, in some examples, the third time unit is not used by the repeater to forward the first signal to the network device, or the third time unit is not used by the repeater to receive the first received signal for obtaining the first signal.

In the above embodiments, in some examples, the third indication information is further used by the repeater to generate the third signal based on the third indication information, the third signal being used to carry information and/or data transmitted by the repeater to the network device, and/or, being used by the network device to perform measurement and/or estimation on a channel and/or a signal from the repeater to the network device.

In some embodiments, the method further comprises:
the network device transmits fourth indication information to the repeater, the fourth indication information being used to indicate that a fourth time unit is used by the repeater to receive a downlink signal transmitted by the network device to the repeater, the fourth time unit being the downlink time unit and/or the flexible time unit in the TDD uplink and downlink configuration.

In the above embodiments, in some examples, the fourth indication information is used to indicate that the fourth time unit in each period of the group of time units of the TDD uplink and downlink configuration is used by the repeater to receive the downlink signal transmitted by the network device to the repeater.

In the above embodiments, in some examples, the fourth indication information is a Physical Downlink Control Channel (PDCCH) or a high-layer signaling. The PDCCH, for example, is a common PDCCH. The high-layer signaling, for example, is a dedicated signaling.

In the above embodiments, in some examples, the fourth indication information is further used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some examples, the first indication information and the fourth indication information are carried by same signaling.

In some embodiments, the method further comprises:
a network device transmits fifth indication information to the repeater, the fifth indication information being used to indicate the repeater to receive a fifth signal from the network device at a fifth time unit, the fifth time unit being the flexible time unit and/or the downlink time unit in the TDD uplink and downlink configuration.

In the above embodiments, in some examples, the fifth signal is used by the repeater to perform demodulating and decoding to obtain information and/or data transmitted by the network device to the repeater, and/or to perform measurement and/or estimation on a channel and/or a signal from the network device to the repeater.

In the above embodiments, in some examples, the fifth time unit is one or more than one time unit, or one or more than one time unit that is periodic.

In the above embodiments, in some examples, the fifth time unit is one or more than one time unit, the fifth indication information is a PDCCH, and the fifth signal is at least one of the following: a PDSCH, a Phase Tracking Reference Signal (PTRS), a CSI-RS, an SSB, an SIB, an activated semi-static PDSCH (SPS-PDSCH).

In the above embodiments, in some examples, the fifth time unit is one or more than one time unit that is periodic, the fifth indication information is a high-layer signaling, and the fifth signal is at least one of the following: a PDCCH, a Time Reference Signal (TRS), an SSB, an SIB, a CSI-RS, a semi-static PDSCH (SPS-PDSCH).

In the above embodiments, in some examples, the fifth signal is an SIB, and the fifth indication information is an SSB and/or a high-layer signaling.

In the above embodiments, in some examples, the fifth signal is used to carry indication information indicating a spatial filter from the network device to the repeater, the indication information including at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

In the above embodiments, the transmitting spatial filter used by the repeater to forward the first signal to the network device is the same as the transmitting spatial filter used by the repeater to transmit the third signal to the network device; and/or, the receiving spatial filter used by the repeater to receive the second signal is the same as the receiving spatial filter used by the repeater to receive the fourth signal from the network device.

In some embodiments, the downlink time unit in the TDD uplink and downlink configuration is further used by the repeater to receive a downlink signal transmitted to the repeater from the network device.

In some embodiments, the uplink time unit in the TDD uplink and downlink configuration is not used by the repeater to transmit an uplink signal generated by the repeater to the network device.

In some embodiments, the uplink time unit in the TDD uplink and downlink configuration is not used by the repeater to transmit an uplink signal generated by the repeater to the network device, and the downlink time unit in the TDD uplink and downlink configuration is not used by the repeater to receive a downlink signal transmitted from the network device to the repeater.

In some embodiments, the network device transmits the first indication information to the repeater in a first cell; the repeater forwards the first signal to the network device in the first cell and/or receives the second signal from the network device in the first cell.

In some embodiments, the first cell is a serving cell of the repeater.

In some embodiments, the first cell is a cell for the repeater to perform initial access; and/or, the first cell is a cell where the repeater establishes an RRC connection with the network device; and/or, the first cell is a cell where the repeater reestablishes an RRC connection with the network device; and/or, the first cell is a cell where the repeater resides; and/or, the first cell is a cell selected by the repeater through a cell process, or a cell re-selected through a cell re-selection process.

In some embodiments, the first cell is a primary cell of the repeater.

In the embodiments of the present disclosure, the repeater may be a repeater station, a radio frequency repeater, a radio frequency relay, a repeater station node, a repeater node, a relay node, an intelligent repeater station, an intelligent repeater, an intelligent relay, an intelligent repeater station node, an intelligent repeater node, an intelligent relay node, etc., however the present disclosure is not limited to this, it may further be other device.

The above only describes steps or processes related to the present disclosure, but the present disclosure is not limited to this. The method in the embodiments of the present disclosure may further comprise other steps or processes. For specific contents of these steps or processes, please refer to relevant technologies.

The above embodiments are only illustrative for the embodiments of the present disclosure, but the present disclosure is not limited to this, appropriate modifications can be also made based on the above embodiments. For example, the above embodiments may be used individually, or one or more of the above embodiments may be combined.

According to the method in the embodiments of the present disclosure, a network device indicates a repeater of the meaning of an uplink time unit and/or a downlink time unit in a TDD uplink and downlink configuration via first indication information, i.e., the uplink time unit is used at least by the repeater to forward a first signal to the network device, and the downlink time unit is used at least by the repeater to receive a second signal from the network device, thereby the repeater can use indication information from the network device to better achieve a function of forwarding a signal, so as to better help the network device to communicate with a third device (such as a terminal equipment), i.e., to enhance the network coverage.

### Embodiments of a Third Aspect

The embodiments of the present disclosure provide a communication apparatus, the apparatus may, for example, be a repeater device, or may also be one or more parts or components configured in the repeater device.

FIG. 4 is a schematic diagram of a communication apparatus in the embodiments of a third aspect of the present disclosure. The principle of the apparatus to solve the problem is the same as the method in the embodiments of the first aspect, thus its specific implementation can refer to the implementation of the method in the embodiments of the first aspect, the same contents will not be repeated.

As shown in FIG. 4, the device 400 in the embodiments of the present disclosure comprises:
a communication unit 401 configured to receive first indication information from a network device, the first indication information being used to indicate a time division duplex (TDD) uplink and downlink configuration, the TDD uplink and downlink configuration at least indicating a group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a received signal, and the downlink time unit is at least used by the repeater to receive a second signal from the network device, the second signal being processed and forwarded by the repeater after being received.

In some embodiments, the first indication information is at least further used to configure a period of the group of time units and/or a subcarrier interval corresponding to the group of time units.

In some embodiments, the first indication information is at least one of the following signalings or information:
Wireless Resource Control (RRC) signaling;
Media Access Control (MAC) signaling; and
physical layer control information.

In the above embodiments, the first indication information at least includes one or more of the following signalings:
a high-layer signaling containing tdd-UL-DL-ConfigurationCommon;
a high-layer signaling containing tdd-UL-DL-ConfiguratingDedicated;
a physical control channel DCI format 2_0, and
a physical control channel DCI format 2_5.

In some embodiments, the time unit is a symbol and/or slot.

In some embodiments, the uplink time unit is a symbol and/or slot, the downlink time unit is a symbol and/or slot, and the flexible time unit is a symbol and/or slot.

In some embodiments, the performing processing on the first received signal by the repeater comprises: at least performing amplification on the first received signal by the repeater; and the performing processing on the second signal by the repeater comprises: at least performing amplification on the second signal by the repeater.

In some embodiments, the forwarding the first signal by the repeater comprises: not performing, by the repeater, demodulating and decoding on the first received signal, performing only the processing on the first received signal to obtain the first signal, and transmitting the first signal to the network device; and the forwarding the processed second signal by the repeater comprises: not performing, by the repeater, demodulating and decoding on the received second signal, performing only the processing on the received second signal, and transmitting the processed second signal.

In some embodiments, the communication unit 401 further receives second indication information from the network device, the second indication information being used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some implementations, the second indication information is used to indicate that the second time unit in each period or a specific period of the group of time units of the TDD uplink and downlink configuration is used by the repeater to transmit the uplink signal generated by the repeater to the network device.

In the above embodiments, in some implementations, the second indication information is a Physical Downlink Control Channel (PDCCH) or high-layer signaling. The PDCCH, for example, is a common PDCCH. The high-layer signaling, for example, is dedicated signaling.

In the above embodiments, in some implementations, the second time unit is not used by the repeater to forward the first signal to the network device, or is not used by the repeater to receive a first received signal for obtaining the first signal.

In some embodiments, the communication unit 401 further receives third indication information from the network device, the third indication information being used to indicate the repeater to transmit a third signal generated by the repeater at a third time unit, the third time unit being the flexible time unit and/or the uplink time unit in the TDD uplink and downlink configuration.

In the above embodiments, in some implementations, the third time unit is one or more than one time unit, or one or more than one time unit that is periodic.

In the above embodiments, in some implementations, the third time unit is one or more than one time unit, the third indication information is a PDCCH, and the third signal is at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

In the above embodiments, in some implementations, the third time unit is one time unit in one period, the third indication information is a high-layer signaling, and the third signal is at least one of the following: a PRACH, a PUCCH, a Demodulation Reference Signal (DMRS).

In the above embodiments, in some implementations, the third time unit is one or more than one time unit that is periodic, the third indication information is a high-layer signaling, the third signal is a Configuration Grant (CG) PUSCH and/or an SRS, and the high-layer signaling is a MAC signaling or an RRC signaling.

In the above embodiments, in some implementations, the third signal is used to carry channel state information, the channel state information being obtained via one or more of the following measurements:
SRS-based measurement according to a configuration of the network device;
Channel State Information Reference Signal (CSI-RS)-based measurement according to a configuration of the network device;
Synchronization Signal Block (SSB)-based measurement according to a configuration of the network device;
Positioning Reference Signal (PRS)-based measurement according to a configuration of the network device; and
Cross Link Interference Reference Signal (CLI-RS)-based measurement according to a configuration of the network device.

In the above embodiments, in some implementations, the third signal is a Random Access Channel (RACH), and the third indication information is at least one of the following: system information, high-layer control information and a PDCCH.

In the above embodiments, in some implementations, the third time unit is not used by the repeater to forward the first signal to the network device, or is not used by the repeater to receive a first received signal for obtaining the first signal.

In some embodiments, as shown in FIG. 4, the apparatus 400 further comprises:
a generating unit 402, configured to generate the third signal based on the third indication information, the third signal being used to carry information and/or data transmitted by the repeater to the network device, and/or, being used by the network device to perform measurement and/or estimating on a channel and/or a signal from the repeater to the network device.

In some embodiments, the communication unit 401 further receives fourth indication information from the network device, the fourth indication information being used to indicate that a fourth time unit is used by the repeater to receive a downlink signal transmitted by the network device to the repeater, the fourth time unit being the downlink time unit and/or the flexible time unit in the TDD uplink and downlink configuration.

In the above embodiments, in some implementations, the fourth indication information is used to indicate that the fourth time unit in each period of the group of time units of the TDD uplink and downlink configuration is used by the repeater to receive the downlink signal transmitted by the network device to the repeater.

In the above embodiments, in some implementations, the fourth indication information is a Physical Downlink Control Channel (PDCCH) or a high-layer signaling. The PDCCH, for example, is a common PDCCH. The high-layer signaling, for example, is a dedicated signaling.

In the above embodiments, in some implementations, the fourth indication information is further used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some implementations, the first indication information and the fourth indication information may be carried by a same signaling.

In some embodiments, the communication unit 401 further receives fifth indication information from the network device, the fifth indication information being used to indicate the repeater to receive a fifth signal from the network device at a fifth time unit, the fifth time unit being the flexible time unit and/or the downlink time unit in the TDD uplink and downlink configuration.

In the above embodiments, in some implementations, the fifth signal is used by the repeater to perform demodulating and decoding to obtain information and/or data transmitted by the network device to the repeater, and/or to perform measurement and/or estimating by the repeater on a channel and/or signal from the network device to the repeater.

In the above embodiments, in some implementations, the fifth time unit is one or more than one time unit, or one or more than one time unit that is periodic.

In the above embodiments, in some implementations, the fifth time unit is one or more than one time unit, the fifth indication information is a PDCCH, and the fifth signal is at least one of the following: a PDSCH, a Phase Tracking Reference Signal (PTRS), a CSI-RS, an SSB, an SIB, an activated semi-static PDSCH (SPS-PDSCH).

In the above embodiments, in some implementations, the fifth time unit is one or more than one time unit that is periodic, the fifth indication information is a high-layer signaling, and the fifth signal is at least one of the following: a PDCCH, a Time Reference Signal (TRS), an SSB, an SIB, a CSI-RS, a semi-static PDSCH (SPS-PDSCH).

In the above embodiments, in some implementations, the fifth signal is an SIB, and the fifth indication information is an SSB and/or a high-layer signaling.

In the above embodiments, in some implementations, the fifth signal is used to carry indication information indicating a spatial filter from the network device to the repeater, the indication information including at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

In the above implementations, optionally, the transmitting spatial filter for the repeater to forward the first signal to the network device is the same as the transmitting spatial filter for the repeater to transmit the third signal to the network device; and/or, the receiving spatial filter for the repeater to receive the second signal is the same as the receiving spatial filter for the repeater to receive the fourth signal from the network device.

In some embodiments, the downlink time unit in the TDD uplink and downlink configuration is further used by the repeater to receive a downlink signal transmitted to the repeater from the network device.

In some embodiments, the communication unit 401 does not transmit the uplink signal generated by the repeater to the network device at the uplink time unit in the TDD uplink and downlink configuration.

In some embodiments, the communication unit 401 does not transmit an uplink signal generated by the repeater to the network device at the uplink time unit in the TDD uplink and downlink configuration; and the communication unit 401 does not receive a downlink signal transmitted from the network device to the repeater in the downlink time unit in the TDD uplink and downlink configuration.

In some embodiments, the communication unit 401 receives the first indication information from the network device in a first cell, and the communication unit 401 forwards the first signal to the network device in the first cell and/or receives the second signal from the network device in the first cell.

In the above embodiments, in some implementations, the first cell is a serving cell of the repeater. For example, the first cell is a cell for the repeater to perform initial access; and/or, the first cell is a cell where the repeater establishes an RRC connection with the network device; and/or, the first cell si a cell where the repeater reestablishes an RRC connection with the network device; and/or, the first cell is a cell where the repeater resides; and/or, the first cell is a cell selected by the repeater through a cell process, or a cell re-selected through a cell re-selection process.

In the above embodiments, in some implementations, the first cell is a primary cell of the repeater.

According to the device in the embodiments of the present application, the repeater can use indication information from the network device to better achieve a function of forwarding a signal, so as to better help the network device to communicate with a third device (for example, a terminal equipment), i.e., to enhance the network coverage.

### Embodiments of a Fourth Aspect

The embodiments of the present disclosure provide a communication apparatus, the apparatus may, for example, be a network device, or may also be one or more parts or components configured in the network device.

FIG. 5 is a schematic diagram of a communication apparatus in the embodiments of a second aspect of the present disclosure. The principle of the apparatus to solve the problem is the same as the method in the embodiments of the first aspect, thus its specific implementation can refer to the implementation of the method in the embodiments of the second aspect, the same contents will not be repeated.

As shown in FIG. 5, the communication apparatus 500 in the embodiments of the present disclosure comprises:
a communication unit 501 configured to transmit first indication information to a repeater, the first indication information being used to indicate time division duplex (TDD) uplink and downlink configuration, the TDD uplink and downlink configuration indicating at least one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

In some embodiments, the first indication information is at least further used to configure a period of the group of time units and/or a subcarrier interval corresponding to the group of time units.

In some embodiments, the first indication information is at least one of the following signalings or information:
Wireless Resource Control (RRC) signaling;
Media Access Control (MAC) signaling; and
physical layer control information.

In the above embodiments, the first indication information at least includes one or more of the following signalings:
a high-layer signaling containing tdd-UL-DL-ConfigurationCommon;
a high-layer signaling containing tdd-UL-DL-ConfiguratingDedicated;
a physical control channel DCI format 2_0, and
a physical control channel DCI format 2_5.

In some embodiments, the time unit is a symbol and/or slot.

In some embodiments, the uplink time unit is a symbol and/or slot, the downlink time unit is a symbol and/or slot, and the flexible time unit is a symbol and/or slot.

In some embodiments, the performing processing on the first received signal by the repeater comprises: at least performing amplification on the first received signal by the repeater; and the performing processing on the second signal by the repeater comprises: at least performing amplification on the second signal by the repeater.

In some embodiments, the uplink time unit is at least used by the repeater to forward the first signal to the network device in the following manner: not performing demodulating and decoding on the first received signal, performing only the processing on the first received signal to obtain the first signal, and transmitting the first signal to the network device; and the downlink time unit is at least used by the repeater to forward the processed second signal in the following manner: not performing demodulating and decoding on the received second signal, performing only the processing on the received second signal, and transmitting the processed second signal.

In some embodiments, the communication unit 501 further transmits second indication information to the repeater, the second indication information being used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some implementations, the second indication information is used to indicate that the second time unit in each period of the group of time units of the TDD uplink and downlink configuration is used by the repeater to transmit the uplink signal generated by the repeater to the network device.

In the above embodiments, in some implementations, the second indication information is a Physical Downlink Control Channel (PDCCH) or a high-layer signaling. The PDCCH, for example, is a common PDCCH. The high-layer signaling, for example, is a dedicated signaling.

In the above embodiments, in some implementations, the second time unit is not used by the repeater to forward the first signal to the network device, or the second time unit is not used by the repeater to receive a first received signal for obtaining the first signal.

In some embodiments, the communication unit 501 further transmits third indication information to the repeater, the third indication information being used to indicate the repeater to transmit a third signal generated by the repeater at a third time unit, the third time unit being the flexible time unit and/or the uplink time unit in the TDD uplink and downlink configuration.

In the above embodiments, in some implementations, the third time unit is one or more than one time unit, or one or more than one time unit that is periodic.

In the above embodiments, in some implementations, the third time unit is one or more than one time unit, the third indication information is a PDCCH, and the third signal is at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

In the above embodiments, in some implementations, the third time unit is one time unit in one period, the third indication information is a high-layer signaling, and the third signal is at least one of the following: a PRACH, a PUCCH, a Demodulation Reference Signal (DMRS).

In the above embodiments, in some implementations, the third time unit is one or more than one time unit that is periodic, the third indication information is a high-layer signaling, the third signal is a Configuration Grant (CG) PUSCH and/or an SRS, and the high-layer signaling is a MAC signaling or an RRC signaling.

In the above embodiments, in some implementations, the third signal is used to carry channel state information, the channel state information being obtained via one or more of the following measurements:
SRS-based measurement configured by the network device for the repeater;
Channel State Information Reference Signal (CSI-RS)-based measurement configured by the network device for the repeater;
Synchronization Signal Block (SSB)-based measurement configured by the network device for the repeater;
Positioning Reference Signal (PRS)-based measurement configured by the network device for the repeater; and
Cross Link Interference Reference Signal (CLI-RS)-based measurement configured by the network device for the repeater.

In the above embodiments, in some implementations, the third signal is a Random Access Channel (RACH), and the third indication information is at least one of the following: system information, high-layer control information and a PDCCH.

In the above embodiments, in some implementations, the third time unit is not used by the repeater to forward the first signal to the network device, or the third time unit is not used by the repeater to receive a first received signal for obtaining the first signal.

In the above embodiments, in some implementations, the third indication information is further used by the repeater to generate the third signal based on the third indication information, the third signal being used to carry information and/or data transmitted by the repeater to the network device, and/or, being used by the network device to perform measurement and/or estimating on a channel and/or a signal from the repeater to the network device.

In some embodiments, the communication unit 501 further transmits fourth indication information to the repeater, the fourth indication information being used to indicate that a fourth time unit is used by the repeater to receive a downlink signal transmitted by the network device to the repeater, the fourth time unit being the downlink time unit and/or the flexible time unit in the TDD uplink and downlink configuration.

In the above embodiments, in some implementations, the fourth indication information is used to indicate that the fourth time unit in each period of the group of time units of the TDD uplink and downlink configuration is used by the repeater to receive the downlink signal transmitted by the network device to the repeater.

In the above embodiments, in some implementations, the fourth indication information is a Physical Downlink Control Channel (PDCCH) or a high-layer signaling. The PDCCH, for example, is a common PDCCH. The high-layer signaling, for example, is a dedicated signaling.

In the above embodiments, in some implementations, the fourth indication information is further used to indicate that a second time unit is used by the repeater to transmit an uplink signal generated by the repeater to the network device, the second time unit being the uplink time unit and/or the flexible time unit in the TDD uplink and downlink configuration.

In the above embodiments, in some implementations, the first indication information and the fourth indication information are carried by a same signaling.

In some embodiments, the communication unit 501 further transmits fifth indication information to the repeater, the fifth indication information being used to indicate the repeater to receive a fifth signal from the network device at a fifth time unit, the fifth time unit being the flexible time unit and/or the downlink time unit in the TDD uplink and downlink configuration.

In the above embodiments, in some implementations, the fifth signal is used by the repeater to perform demodulating and decoding to obtain information and/or data transmitted by the network device to the repeater, and/or to perform measurement and/or estimating by the repeater on a channel and/or signal from the network device to the repeater.

In the above embodiments, in some implementations, the fifth time unit is one or more than one time unit, or one or more than one time unit that is periodic.

In the above embodiments, in some implementations, the fifth time unit is one or more than one time unit, the fifth indication information is a PDCCH, and the fifth signal is at least one of the following: a PDSCH, a Phase Tracking Reference Signal (PTRS), a CSI-RS, an SSB, an SIB, an activated semi-static PDSCH (SPS-PDSCH).

In the above embodiments, in some implementations, the fifth time unit is one or more than one time unit that is periodic, the fifth indication information is a high-layer signaling, and the fifth signal is at least one of the following: a PDCCH, a Time Reference Signal (TRS), an SSB, an SIB, a CSI-RS, a semi-static PDSCH (SPS-PDSCH).

In the above embodiments, in some implementations, the fifth signal is an SIB, and the fifth indication information is an SSB and/or a high-layer signaling.

In the above embodiments, in some implementations, the fifth signal is used to carry indication information indicating a spatial filter from the network device to the repeater, the indication information including at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

In the above embodiments, in some implementations, the transmitting spatial filter for the repeater to forward the first signal to the network device is the same as the transmitting spatial filter for the repeater to transmit the third signal to the network device; and/or, the receiving spatial filter for the repeater to receive the second signal is the same as the receiving spatial filter for the repeater to receive the fourth signal from the network device.

In some embodiments, the downlink time unit in the TDD uplink and downlink configuration is further used by the repeater to receive a downlink signal transmitted to the repeater from the network device.

In some embodiments, the uplink time unit in the TDD uplink and downlink configuration is not used by the repeater to transmit an uplink signal generated by the repeater to the network device.

In some embodiments, the uplink time unit in the TDD uplink and downlink configuration is not used by the repeater to transmit an uplink signal generated by the repeater to the network device; and the downlink time unit in the TDD uplink and downlink configuration is not used by the repeater to receive a downlink signal transmitted from the network device to the repeater.

In some embodiments, the communication unit 501 transmits the first indication information to the repeater in a first cell, and the communication unit 501 receives the first signal from the repeater in the first cell and/or transmits the second signal to the repeater in the first cell.

In the above embodiments, in some implementations, the first cell is a serving cell of the repeater. For example, the first cell is a cell for the repeater to perform initial access; and/or, the first cell is a cell where the repeater establishes an RRC connection with the network device; and/or, the first cell is a cell where the repeater reestablishes an RRC connection with the network device; and/or, the first cell is a cell where the repeater resides; and/or, the first cell is a cell selected by the repeater through a cell process, or a cell re-selected through a cell re-selection process.

In the above embodiments, in some implementations, the first cell is a primary cell of the repeater.

According to the device in the embodiments of the present application, the repeater can use indication information from the network device to better achieve a function of forwarding a signal, so as to better help the network device to communicate with a third device (for example, a terminal equipment), i.e., to enhance the network coverage.

### Embodiments of a Fifth Aspect

The embodiments of the present disclosure provide a communication system. FIG. 1 is a schematic diagram of a communication system in the embodiments of the present disclosure. As shown in FIG. 1, the communication system 100 comprises a network device 101, a repeater 102 and a terminal equipment 103. For the sake of simplicity, FIG. 1 only takes one network device, one repeater and one terminal equipment as examples to describe, but the embodiments of the present disclosure are not limited to this.

In the embodiments of the present disclosure, transmission of existing or further implementable services can be carried out between the network device 101 and the terminal equipment 103. For example, these services may include but be not limited to: enhanced Mobile Broadband (eMBB), massive Machine Type Communication (mMTC), Ultra-Reliable Low-Latency Communication (URLLC), Internet of Vehicles (V2X) communication and so on.

In the embodiments of the present disclosure, the network device 101 is configured to perform the method described in the embodiments of the second aspect, and the repeater 102 is configured to perform the method described in the embodiments of the first aspect, their contents are incorporated here and are not repeated here.

The embodiments of the present disclosure further provides a repeater, the repeater e.g. may be a repeater station, a radio frequency repeater, a radio frequency relay, a repeater station node, a repeater node, a relay node, an intelligent repeater station, an intelligent repeater, an intelligent relay, an intelligent repeater station node, an intelligent repeater node, an intelligent relay node, etc., however the present disclosure is not limited to this, it may further be other device.

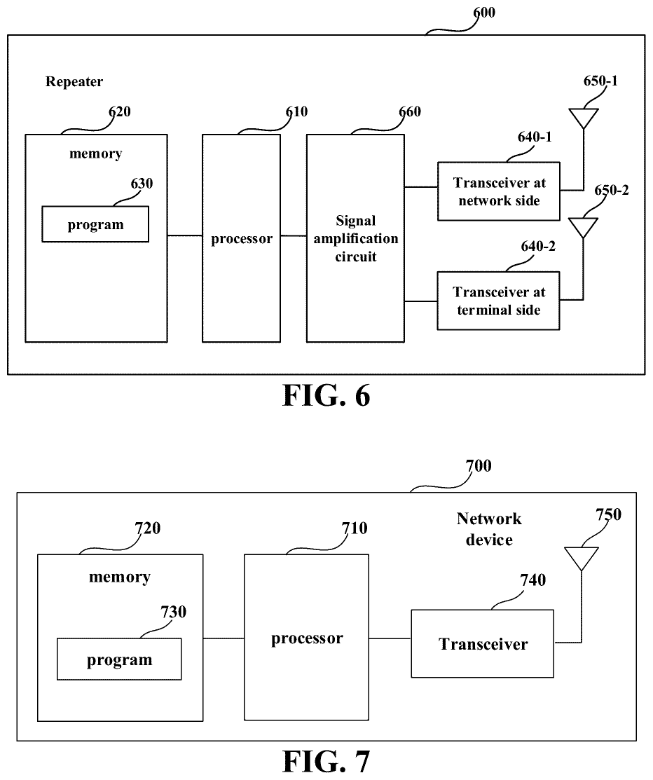

FIG. 6 is a schematic diagram of a repeater in the embodiments of the present disclosure. As shown in FIG. 6, the repeater 600 may include a processor 610 and a memory 620; the memory 620 stores data and programs 630, and is coupled to the processor 610. It's worth noting that this figure is exemplary; other types of structures can also be used to supplement or replace this structure, so as to realize a telecommunication function or other functions.

For example, the processor 610 can be configured to execute a program to implement the method as described in the embodiments of the first aspect.

As shown in FIG. 6, the repeater 600 may further comprise: a network side transceiver 640-1 and a network side antenna 650-1, a terminal side transceiver 640-2 and a terminal side antenna 650-2, and a signal amplification circuit 660, etc.; the functions of said components are similar to relevant arts, which are not repeated here. It's worth noting that the repeater 600 does not have to include all the components shown in FIG. 6. Moreover, the repeater 600 may also include components not shown in FIG. 6, related arts may be referred to.

The embodiments of the present disclosure further provide a network device, the network device e.g. may be a base station (gNB), but the present disclosure is not limited to this, it may also be other network device.

FIG. 7 is a composition schematic diagram of a network device in the embodiments of the present disclosure. As shown in FIG. 7, the network device 700 may include: a processor 710 (such as a central processing unit (CPU)) and a memory 720; the memory 720 is coupled to the processor 710. The memory 720 can store various data; moreover, also stores a program 730 for information processing, and executes the program 730 under the control of the processor 710.

For example, the processor 710 can be configured to execute a program to implement the method as described in the embodiments of the second aspect.

In addition, as shown in FIG. 7, the network device 700 may further include: a transceiver 740 and an antenna 750, etc.; wherein the functions of said components are similar to relevant arts, which are not repeated here. It's worth noting that the network device 700 does not have to include all the components shown in FIG. 7. Moreover, the network device 700 may also include components not shown in FIG. 7, relevant arts can be referred to.

The embodiments of the present disclosure further provide a computer readable program, wherein when the program is executed in a repeater, the program enables a computer to execute the method as described in the embodiments of the first aspect, in the repeater.

The embodiments of the present disclosure further provide a storage medium in which a computer readable program is stored, wherein the computer readable program enables a computer to execute the method as described in the embodiments of the first aspect, in a repeater.

The embodiments of the present disclosure further provide a computer readable program, wherein when a network device executes the program, the program enables a computer in the network device to execute the method described in the embodiments of the second aspect.

The embodiments of the present disclosure further provide a storage medium in which a computer readable program is stored, wherein the computer readable program enables a computer to execute the method as described in the embodiments of the second aspect, in a network device.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The logic component is e.g. a field programmable logic component, a microprocessor, a processor used in a computer, etc. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium can be coupled to a processor, thereby enabling the processor to read information from the storage medium, and to write the information into the storage medium; or the storage medium can be a constituent part of the processor. The processor and the storage medium can be located in an ASIC. The software module can be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the drawings can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the spirit and principle of the present disclosure, these variations and modifications are also within the scope of the present disclosure.

Regarding the above implementations disclosed in this embodiment, the following supplements are further disclosed:

1. A communication method, wherein the method comprises:
receiving, by a repeater, first indication information from a network device, the first indication information being used to indicate a time division duplex (TDD) uplink and downlink configuration, the TDD uplink and downlink configuration at least indicating a group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

2. The method according to Supplement 1, wherein
the first indication information is at least further used to configure a period of the group of time units and/or a subcarrier interval corresponding to the group of time units.

3. The method according to Supplement 1 or 2, wherein the first indication information is at least one of the following signalings or information:
Wireless Resource Control (RRC) signaling;
Media Access Control (MAC) signaling; and
physical layer control information.

4. The method according to Supplement 3, wherein the first indication information at least includes one or more of the following signalings:
a high-layer signaling containing tdd-UL-DL-ConfigurationCommon;
a high-layer signaling containing tdd-UL-DL-ConfiguratingDedicated;
a physical control channel DCI format 2_0, and
a physical control channel DCI format 2_5.

5. The method according to any one of Supplements 1 to 4, wherein the time unit is a symbol and/or a slot.

6. The method according to Supplement 5, wherein
the uplink time unit is a symbol and/or slot, the downlink time unit is a symbol and/or slot, and the flexible time unit is a symbol and/or slot.

7. The method according to any one of Supplements 1 to 6, wherein
the performing processing on the first received signal by the repeater comprises: at least performing amplification on the first received signal by the repeater;
and the performing processing on the second signal by the repeater comprises: at least performing amplification on the second signal by the repeater.

8. The method according to any one of Supplements 1 to 7, wherein
the forwarding the first signal by the repeater comprises: not performing demodulating and decoding on the first received signal by the repeater, performing only the processing on the first received signal to obtain the first signal, and transmitting the first signal to the network device;
and the forwarding the processed second signal by the repeater comprises: not performing demodulating and decoding on the received second signal by the repeater, performing only the processing on the received second signal, and transmitting the processed second signal.

9. The method according to any one of Supplements 1 to 8, wherein the method further comprises:
receiving, by the repeater, second indication information from the network device, the second indication information being used to indicate that a second time unit is used by the repeater to transmit an uplink signal generated by the repeater to the network device, the second time unit being the uplink time unit and/or the flexible time unit in the TDD uplink and downlink configuration.

10. The method according to Supplement 9, wherein
the second indication information is used to indicate that the second time unit in each period or a specific period of the group of time units of the TDD uplink and downlink configuration is used by the repeater to transmit the uplink signal generated by the repeater to the network device.

11. The method according to Supplement 9, wherein
the second indication information is a Physical Downlink Control Channel (PDCCH) or a high-layer signaling.

12. The method according to Supplement 11, wherein
the PDCCH is a common PDCCH.

13. The method according to Supplement 11, wherein
the high-layer signaling is a dedicated signaling.

14. The method according to Supplement 9, wherein the second time unit is not used by the repeater to forward the first signal to the network device, or is not used by the repeater to receive a first received signal for obtaining the first signal.

15. The method according to any one of Supplements 1 to 8, wherein the method further comprises:
receiving, by the repeater, third indication information from the network device, the third indication information being used to indicate the repeater to transmit a third signal generated by the repeater at a third time unit, the third time unit being the flexible time unit and/or the uplink time unit in the TDD uplink and downlink configuration.

16. The method according to Supplement 15, wherein the third time unit is one or more than one time unit, or one or more than one time unit that is periodic.

17. The method according to Supplement 15, wherein the third time unit is one or more than one time unit, the third indication information is a PDCCH, and the third signal is at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

18. The method according to Supplement 15, wherein the third time unit is one time unit in one period, the third indication information is a high-layer signaling, and the third signal is at least one of the following: a PRACH, a PUCCH, a Demodulation Reference Signal (DMRS).

19. The method according to Supplement 15, wherein the third time unit is one or more than one time unit that is periodic, the third indication information is a high-layer signaling, the third signal is a Configuration Grant (CG) PUSCH and/or an SRS, and the high-layer signaling is a MAC signaling or an RRC signaling.

20. The method according to Supplement 15, wherein the third signal is used to carry channel state information, the channel state information being obtained via one or more of the following measurements:
SRS-based measurement according to a configuration of the network device;
Channel State Information Reference Signal (CSI-RS)-based measurement according to a configuration of the network device;
Synchronization Signal Block (SSB)-based measurement according to a configuration of the network device;
Positioning Reference Signal (PRS)-based measurement according to a configuration of the network device; and
Cross Link Interference Reference Signal (CLI-RS)-based measurement according to a configuration of the network device.

21. The method according to Supplement 15, wherein the third signal is a Random Access Channel (RACH), and the third indication information is at least one of the following: system information, high-layer control information and a PDCCH.

22. The method according to Supplement 15, wherein the third time unit is not used by the repeater to forward the first signal to the network device, or is not used by the repeater to receive a first received signal for obtaining the first signal.

23. The method according to Supplement 15, wherein the method further comprises:
generating, by the repeater, the third signal based on the third indication information, the third signal being used to carry information and/or data transmitted by the repeater to the network device, and/or, being used by the network device to perform measurement and/or estimating on a channel and/or a signal from the repeater to the network device.

24. The method according to any one of Supplements 1 to 23, wherein the method further comprises:
receiving, by the repeater, fourth indication information from the network device, the fourth indication information being used to indicate that a fourth time unit is used by the repeater to receive a downlink signal transmitted by the network device to the repeater, the fourth time unit being the downlink time unit and/or the flexible time unit in the TDD uplink and downlink configuration.

25. The method according to Supplement 24, wherein
the fourth indication information is used to indicate that the fourth time unit in each period of the group of time units of the TDD uplink and downlink configuration is used by the repeater to receive the downlink signal transmitted by the network device to the repeater.

26. The method according to Supplement 24 or 25, wherein
the fourth indication information is a Physical Downlink Control Channel (PDCCH) or a high-layer signaling.

27. The method according to Supplement 26, wherein
the PDCCH is a common PDCCH.

28. The method according to Supplement 26, wherein
the high-layer signaling is a dedicated signaling.

29. The method according to Supplement 25, wherein
the fourth indication information is further used to indicate that a second time unit is used by the repeater to transmit an uplink signal generated by the repeater to the network device, the second time unit being the uplink time unit and/or the flexible time unit in the TDD uplink and downlink configuration.

30. The method according to any one of Supplements 24 to 29, wherein
the first indication information and the fourth indication information are carried by a same signaling.

31. The method according to any one of Supplements 1 to 23, wherein the method further comprises:
receiving, by the repeater, fifth indication information from the network device, the fifth indication information being used to indicate the repeater to receive a fifth signal from the network device at a fifth time unit, the fifth time unit being the flexible time unit and/or the downlink time unit in the TDD uplink and downlink configuration.

32. The method according to Supplement 31, wherein the fifth signal is used by the repeater to perform demodulating and decoding to obtain information and/or data transmitted by the network device to the repeater, and/or to perform measurement and/or estimating by the repeater on a channel and/or signal from the network device to the repeater.

33. The method according to Supplement 31, wherein the fifth time unit is one or more than one time unit, or one or more than one time unit that is periodic.

34. The method according to Supplement 33, wherein the fifth time unit is one or more than one time unit, the fifth indication information is a PDCCH, and the fifth signal is at least one of the following: a PDSCH, a Phase Tracking Reference Signal (PTRS), a CSI-RS, an SSB, an SIB, an activated semi-static PDSCH (SPS-PDSCH).

35. The method according to Supplement 33, wherein the fifth time unit is one or more than one time unit that is periodic, the fifth indication information is a high-layer signaling, and the fifth signal is at least one of the following: a PDCCH, a Time Reference Signal (TRS), an SSB, an SIB, a CSI-RS, a semi-static PDSCH (SPS-PDSCH).

36. The method according to Supplement 31, wherein the fifth signal is an SIB, and the fifth indication information is an SSB and/or a high-layer signaling.

37. The method according to Supplement 31, wherein the fifth signal is used to carry indication information indicating a spatial filter from the network device to the repeater, the indication information including at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

38. The method according to Supplement 37, wherein
the transmitting spatial filter for the repeater to forward the first signal to the network device is the same as the transmitting spatial filter for the repeater to transmit the third signal to the network device; and/or
the receiving spatial filter for the repeater to receive the second signal is the same as the receiving spatial filter for the repeater to receive the fourth signal from the network device.

39. The method according to any one of Supplements 1 to 38, wherein
the downlink time unit in the TDD uplink and downlink configuration is further used by the repeater to receive a downlink signal transmitted to the repeater from the network device.

40. The method according to any one of Supplements 1 to 38, wherein
the repeater does not transmit the uplink signal generated by the repeater to the network device at the uplink time unit in the TDD uplink and downlink configuration.

41. The method according to any one of Supplements 1 to 38, wherein
the repeater does not transmit an uplink signal generated by the repeater to the network device at the uplink time unit in the TDD uplink and downlink configuration; and,
the repeater does not receive a downlink signal transmitted to the repeater from the network device at the downlink time unit in the TDD uplink and downlink configuration.

42. The method according to any one of Supplements 1 to 41, wherein
the repeater receives the first indication information from the network device in a first cell, and the repeater forwards the first signal to the network device in the first cell and/or receives the second signal from the network device in the first cell.

43. The method according to Supplement 42, wherein the first cell is a serving cell of the repeater.

44. The method according to Supplement 42 or 43, wherein
the first cell is a cell for the repeater to perform initial access; and/or,
the first cell is a cell where the repeater establishes an RRC connection with a network device; and/or,
the first cell is a cell where the repeater reestablishes an RRC connection with a network device; and/or,
the first cell is a cell where the repeater resides; and/or,
the first cell is a cell selected by the repeater through a cell process, or a cell re-selected through a cell re-selection process.

45. The method according to Supplement 43, wherein the first cell is a primary cell of the repeater.

1a. A communication method, wherein the method comprises:
transmitting, by a network device, first indication information to a repeater, the first indication information being used to indicate time division duplex (TDD) uplink and downlink configuration, the TDD uplink and downlink configuration indicating at least one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

2a. The method according to Supplement 1a, wherein
the first indication information is at least further used to configure a period of the group of time units and/or a subcarrier interval corresponding to the group of time units.

3a. The method according to Supplement 1a or 2a, wherein the first indication information is at least one of the following signalings or information:
Wireless Resource Control (RRC) signaling;
Media Access Control (MAC) signaling; and
physical layer control information.

4a. The method according to Supplement 3a, wherein the first indication information at least includes one or more of the following signalings:
a high-layer signaling containing tdd-UL-DL-ConfigurationCommon;
a high-layer signaling containing tdd-UL-DL-ConfiguratingDedicated;
a physical control channel DCI format 2_0, and
a physical control channel DCI format 2_5.

5a. The method according to any one of Supplements 1a to 4a, wherein the time unit is a symbol and/or a slot.

6a. The method according to Supplement 5a, wherein
the uplink time unit is a symbol and/or slot, the downlink time unit is a symbol and/or slot, and the flexible time unit is a symbol and/or slot.

7a. The method according to any one of Supplements 1a to 6a, wherein
the performing processing on the first received signal by the repeater comprises: at least performing amplification on the first received signal by the repeater;
and the performing processing on the second signal by the repeater comprises: at least performing amplification on the second signal by the repeater.

8a. The method according to any one of Supplements 1a to 7a, wherein
the uplink time unit is at least used by the repeater to forward the first signal to the network device in the following manner: not performing demodulating and decoding on the first received signal, performing only the processing on the first received signal to obtain the first signal, and transmitting the first signal to the network device;
and the downlink time unit is at least used by the repeater to forward the processed second signal in the following manner: not performing demodulating and decoding on the received second signal, performing only the processing on the received second signal, and transmitting the processed second signal.

9a. The method according to any one of Supplements 1a to 8a, wherein the method further comprises:
transmitting, by the network device, second indication information to the repeater, the second indication information being used to indicate that a second time unit is used by the repeater to transmit an uplink signal generated by the repeater to the network device, the second time unit being the uplink time unit and/or the flexible time unit in the TDD uplink and downlink configuration.

10a. The method according to Supplement 9a, wherein
the second indication information is used to indicate that the second time unit in each period of the group of time units of the TDD uplink and downlink configuration is used by the repeater to transmit the uplink signal generated by the repeater to the network device.

11a. The method according to Supplement 9a, wherein
the second indication information is a Physical Downlink Control Channel (PDCCH) or a high-layer signaling.

12a. The method according to Supplement 11a, wherein
the PDCCH is a common PDCCH.

13a. The method according to Supplement 11a, wherein
the high-layer signaling is a dedicated signaling.

14a. The method according to Supplement 9a, wherein the second time unit is not used by the repeater to forward the first signal to the network device, or the second time unit is not used by the repeater to receive a first received signal for obtaining the first signal.

15a. The method according to any one of Supplements 1a to 8a, wherein the method further comprises:
transmitting, by the network device, third indication information to the repeater, the third indication information being used to indicate the repeater to transmit a third signal generated by the repeater at a third time unit, the third time unit being the flexible time unit and/or the uplink time unit in the TDD uplink and downlink configuration.

16a. The method according to Supplement 15a, wherein the third time unit is one or more than one time unit, or one or more than one time unit that is periodic.

17a. The method according to Supplement 15a, wherein the third time unit is one or more than one time unit, the third indication information is a PDCCH, and the third signal is at least one of the following: a dynamic Physical Uplink Shared Channel (PUSCH), a Sounding Reference Signal (SRS), a Physical Random Access Channel (PRACH), a Physical Uplink Control Channel (PUCCH), an activated Configuration Grant (CG) PUSCH.

18a. The method according to Supplement 15a, wherein the third time unit is one time unit in one period, the third indication information is a high-layer signaling, and the third signal is at least one of the following: a PRACH, a PUCCH, a Demodulation Reference Signal (DMRS).

19a. The method according to Supplement 15a, wherein the third time unit is one or more than one time unit that is periodic, the third indication information is a high-layer signaling, the third signal is a Configuration Grant (CG) PUSCH and/or an SRS, and the high-layer signaling is a MAC signaling or an RRC signaling.

20a. The method according to Supplement 15a, wherein the third signal is used to carry channel state information, the channel state information being obtained via one or more of the following measurements:
SRS-based measurement configured by the network device for the repeater;
Channel State Information Reference Signal (CSI-RS)-based measurement configured by the network device for the repeater;
Synchronization Signal Block (SSB)-based measurement configured by the network device for the repeater;
Positioning Reference Signal (PRS)-based measurement configured by the network device for the repeater; and
Cross Link Interference Reference Signal (CLI-RS)-based measurement configured by the network device for the repeater.

21a. The method according to Supplement 15a, wherein the third signal is a Random Access Channel (RACH), and the third indication information is at least one of the following: system information, high-layer control information and a PDCCH.

22a. The method according to Supplement 15a, wherein the third time unit is not used by the repeater to forward the first signal to the network device, or the third time unit is not used by the repeater to receive a first received signal for obtaining the first signal.

23a. The method according to Supplement 15a, wherein
the third indication information is further used by the repeater to generate the third signal according to the third indication information, the third signal being used to carry information and/or data transmitted by the repeater to the network device, and/or, being used by the network device to perform measurement and/or estimating on a channel and/or a signal from the repeater to the network device.

24a. The method according to any one of Supplements 1a to 23a, wherein the method further comprises:
transmitting, by the network device, fourth indication information to the repeater, the fourth indication information being used to indicate that a fourth time unit is used by the repeater to receive a downlink signal transmitted by the network device to the repeater, the fourth time unit being the downlink time unit and/or the flexible time unit in the TDD uplink and downlink configuration.

25a. The method according to Supplement 24a, wherein
the fourth indication information is used to indicate that the fourth time unit in each period of the group of time units of the TDD uplink and downlink configuration is used by the repeater to receive the downlink signal transmitted by the network device to the repeater.

26a. The method according to Supplement 24a or 25a, wherein
the fourth indication information is a Physical Downlink Control Channel (PDCCH) or a high-layer signaling.

27a. The method according to Supplement 26a, wherein
the PDCCH is a common PDCCH.

28a. The method according to Supplement 26a, wherein
the high-layer signaling is a dedicated signaling.

29a. The method according to Supplement 25a, wherein
the fourth indication information is further used to indicate that a second time unit is used by the repeater to transmit an uplink signal generated by the repeater to the network device, the second time unit being the uplink time unit and/or the flexible time unit in the TDD uplink and downlink configuration.

30a. The method according to any one of Supplements 24a to 29a, wherein
the first indication information and the fourth indication information are carried by a same signaling.

31a. The method according to any one of Supplements 1a to 23a, wherein the method further comprises:
transmitting, by a network device, fifth indication information to the repeater, the fifth indication information being used to indicate the repeater to receive a fifth signal from the network device at a fifth time unit, the fifth time unit being the flexible time unit and/or the downlink time unit in the TDD uplink and downlink configuration.

32a. The method according to Supplement 31a, wherein the fifth signal is used by the repeater to perform demodulating and decoding to obtain information and/or data transmitted by the network device to the repeater, and/or to perform measurement and/or estimating by the repeater on a channel and/or signal from the network device to the repeater.

33a. The method according to Supplement 31a, wherein the fifth time unit is one or more than one time unit, or one or more than one time unit that is periodic.

34a. The method according to Supplement 33a, wherein the fifth time unit is one or more than one time unit, the fifth indication information is a PDCCH, and the fifth signal is at least one of the following: a PDSCH, a Phase Tracking Reference Signal (PTRS), a CSI-RS, an SSB, an SIB, an activated semi-static PDSCH (SPS-PDSCH).

35a. The method according to Supplement 33a, wherein the fifth time unit is one or more than one time unit that is periodic, the fifth indication information is a high-layer signaling, and the fifth signal is at least one of the following: a PDCCH, a Time Reference Signal (TRS), an SSB, an SIB, a CSI-RS, a semi-static PDSCH (SPS-PDSCH).

36a. The method according to Supplement 31a, wherein the fifth signal is an SIB, and the fifth indication information is an SSB and/or a high-layer signaling.

37a. The method according to Supplement 31a, wherein the fifth signal is used to carry indication information indicating a spatial filter from the network device to the repeater, the indication information including at least one of the following:
a receiving spatial filter for the repeater to receive a first received signal, the first received signal being used to obtain the first signal;
a transmitting spatial filter for the repeater to forward the first signal to the network device;
a receiving spatial filter for the repeater to receive the second signal;
a transmitting spatial filter for the repeater to forward the processed second signal;
a transmitting spatial filter for the repeater to transmit a third signal to the network device, the third signal being an uplink signal generated by the repeater; and
a receiving spatial filter for the repeater to receive the fourth signal from the network device.

38a. The method according to Supplement 37a, wherein
the transmitting spatial filter for the repeater to forward the first signal to the network device is the same as the transmitting spatial filter for the repeater to transmit the third signal to the network device; and/or
the receiving spatial filter for the repeater to receive the second signal is the same as the receiving spatial filter for the repeater to receive the fourth signal from the network device.

39a. The method according to any one of Supplements 1a to 38a, wherein
the downlink time unit in the TDD uplink and downlink configuration is further used by the repeater to receive a downlink signal transmitted to the repeater from the network device.

40a. The method according to any one of Supplements 1a to 38a, wherein
the uplink time unit in the TDD uplink and downlink configuration is not used by the repeater to transmit an uplink signal generated by the repeater to the network device.

41a. The method according to any one of Supplements 1a to 38a, wherein
the uplink time unit in the TDD uplink and downlink configuration is not used by the repeater to transmit an uplink signal generated by the repeater to the network device; and
the downlink time unit in the TDD uplink and downlink configuration is not used by the repeater to receive a downlink signal transmitted to the repeater from the network device.

42a. The method according to any one of Supplements 1a to 41a, wherein the network device transmits the first indication information to the repeater in a first cell, and the network device receives the first signal from the repeater in the first cell and/or transmits the second signal to the repeater in the first cell.

43a. The method according to Supplement 42a, wherein the first cell is a serving cell of the repeater.

44a. The method according to Supplement 42a or 43a, wherein
the first cell is a cell for the repeater to perform initial access; and/or,
the first cell is a cell where the repeater establishes an RRC connection with a network device; and/or,
the first cell is a cell where the repeater reestablishes an RRC connection with a network device; and/or,
the first cell is a cell where the repeater resides; and/or,
the first cell is a cell selected by the repeater through a cell process, or a cell re-selected through a cell re-selection process.

45a. The method according to Supplement 43a, wherein the first cell is a primary cell of the repeater.

1b. A repeater, comprising a memory and a processor, the memory storing a computer program, and the processor being configured to execute the method according to any one of the supplements 1 to 45.

1c. A network device, comprising a memory and a processor, the memory storing a computer program, and the processor being configured to execute the method according to any one of the supplements 1a to 45a.

1d. A communication system, comprising a network device and a repeater, wherein
the network device is configured to transmit first indication information to the repeater, the first indication information being used to indicate time division duplex (TDD) uplink and downlink configuration, the TDD uplink and downlink configuration indicating at least one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit;
wherein the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received;
the repeater is configured to receive the first indication information transmitted by the network device.

1. A communication apparatus, configured in a repeater, the communication apparatus comprising:
a receiver configured to receive first indication information from a network device, the first indication information being used to indicate a time division duplex (TDD) uplink and downlink configuration, the TDD uplink and downlink configuration at least indicating a group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit, wherein
the uplink time unit is a symbol and/or a slot, the downlink time unit is a symbol and/or a slot, and the flexible time unit is a symbol and/or a slot, and
the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

2. The communication apparatus according to claim 1, wherein,
the first indication information is at least further used to configure a period of the group of time units and/or a subcarrier spacing corresponding to the group of time units, and
the first indication information is included in radio resource control (RRC) signaling, higher-layer signaling comprising tdd-UL-DL-ConfigurationCommon, and/or higher-layer signaling comprising tdd-UL-DL-ConfiguratingDedicated.

3. The communication apparatus according to claim 1, further comprising
a processor configured to control to amplify the first received signal to obtain the first signal and control to amplify the received second signal,
a first transmitter configured to transmit the first signal to the network device, and
a second transmitter configured to transmit the amplified second signal.

4. The communication apparatus according to claim 1, wherein,
the receiver further receives fifth indication information from the network device, the fifth indication information being used to indicate the repeater to receive a fifth signal at a fifth time unit from the network device, the fifth time unit being the flexible time unit and/or the downlink time unit in the TDD uplink and downlink configuration, and the fifth signal being used by the repeater to perform demodulation and decoding to obtain information transmitted by the network device to the repeater,
the fifth indication information being a PDCCH, the fifth time unit being one or more time units, and the fifth signal being a PDSCH, or, the fifth indication information being higher-layer signaling, the fifth time unit being one or more periodic time units, and the fifth signal being a PDCCH, and
the fifth signal being used to carry a transmission space filter used by the repeater to transmit a third signal to the network device and/or a reception space filter used by the repeater to receive a fourth signal from the network device, the third signal being an uplink signal generated by the repeater, and the fourth signal being a downlink signal transmitted by the network device to the repeater.

5. The communication apparatus according to claim 1, wherein,
a transmission space filter used by the repeater to transmit third signal to the network device is identical to a transmission space filter used by the repeater to forward the first signal to the network device; and/or
a reception space filter used by the repeater to receive fourth signal from the network device is identical to a reception space filter used by the repeater to receive the second signal.

6. The communication apparatus according to claim 1, wherein,
the receiver is further configured to receive sixth indication information from the network device, the sixth indication information being used to indicate the repeater to receive at a sixth time unit a sixth signal from the network device, the sixth time unit being the flexible time unit and/or the downlink time unit in the TDD uplink and downlink configuration, and the sixth signal being used by the repeater to perform demodulation and decoding to obtain the information transmitted by the network device to the repeater,
the sixth indication information being a PDCCH, the sixth time unit being one or more time units, and the sixth signal being a PDSCH,
and the sixth signal being used to carry the transmission space filter used by the repeater to transmit the first signal to the network device and/or the reception space filter used by the repeater to receive the second signal.

7. The communication apparatus according to claim 1, wherein,
the receiver is further configured to receive seventh indication information from the network device, the seventh indication information being used to indicate the repeater to receive at a seventh time unit a seventh signal from the network device, the seventh time unit being the flexible time unit and/or the downlink time unit in the TDD uplink and downlink configuration, and the seventh signal being used by the repeater to perform demodulation and decoding to obtain the information transmitted by the network device to the repeater,
the seventh indication information being a PDCCH, the seventh time unit being one or more time units, and the seventh signal being a PDSCH, or, the seventh indication information being higher-layer signaling, the seventh time unit being one or more periodic time units, and the seventh signal being a PDCCH,
and the seventh signal being used to carry a transmission space filter used by the repeater to forward the processed second signal and/or a reception space filter used by the repeater to receive the first received signal.

8. The communication apparatus according to claim 1, wherein,
the receiver is further configured to receive the first indication information from the network device in a first cell, the first cell being a serving cell of the repeater.

9. A communication apparatus, configured in a network device, wherein the communication apparatus comprising:
a transmitter configured to transmit first indication information to a repeater, the first indication information being used to indicate time division duplex (TDD) uplink and downlink configuration, the TDD uplink and downlink configuration at least indicating one group of time units, the group of time units including one of the following:
a downlink time unit;
a downlink time unit and a flexible time unit;
a downlink time unit, a flexible time unit and an uplink time unit;
a flexible time unit and an uplink time unit; and
an uplink time unit, wherein
the uplink time unit is a symbol and/or a slot, the downlink time unit is a symbol and/or a slot, and the flexible time unit is a symbol and/or a slot, and
the uplink time unit is at least used by the repeater to forward a first signal to the network device, the first signal being obtained by the repeater by performing processing on a first received signal, and the downlink time unit is at least used by the repeater to receive a second signal from the network device, the second signal being processed and forwarded by the repeater after being received.

10. The communication apparatus according to claim 9, wherein,
the first indication information is at least further used to configure a period of the group of time units and/or a subcarrier spacing corresponding to the group of time units, and
the first indication information is included in radio resource control (RRC) signaling, higher-layer signaling comprising tdd-UL-DL-ConfigurationCommon, and/or higher-layer signaling comprising tdd-UL-DL-ConfiguratingDedicated.

11. The communication apparatus according to claim 9, wherein,
the forwarding the first signal by the repeater comprises: amplifying the first received signal to obtain the first signal, and transmitting the first signal to the network device, by the repeater;
and the forwarding the processed second signal by the repeater comprises: amplifying the received second signal, and transmitting the amplified second signal, by the repeater.

12. The communication apparatus according to claim 9, wherein,
the transmitter is further configured to transmit fifth indication information to the repeater, the fifth indication information being used to indicate the repeater to receive a fifth signal at a fifth time unit from the network device, the fifth time unit being the flexible time unit and/or the downlink time unit in the TDD uplink and downlink configuration, and the fifth signal being used by the repeater to perform demodulation and decoding to obtain information transmitted by the network device to the repeater,
the fifth indication information being a PDCCH, the fifth time unit being one or more time units, and the fifth signal being a PDSCH, or, the fifth indication information being higher-layer signaling, the fifth time unit being one or more periodic time units, and the fifth signal being a PDCCH,
and the fifth signal being used to carry a transmission space filter used by the repeater to transmit a third signal to the network device and/or a reception space filter used by the repeater to receive a fourth signal from the network device, the third signal being an uplink signal generated by the repeater, and the fourth signal being a downlink signal transmitted by the network device to the repeater.

13. The communication apparatus according to claim 9, wherein,
a transmission space filter used by the repeater to transmit third signal to the network device is identical to a transmission space filter used by the repeater to forward the first signal to the network device; and/or
a reception space filter used by the repeater to receive fourth signal from the network device is identical to a reception space filter used by the repeater to receive the second signal.

14. The communication apparatus according to claim 9, wherein,
the transmitter is further configured to transmit sixth indication information to the repeater, the sixth indication information being used to indicate the repeater to receive at a sixth time unit a sixth signal from the network device, the sixth time unit being the flexible time unit and/or the downlink time unit in the TDD uplink and downlink configuration, and the sixth signal being used by the repeater to perform demodulation and decoding to obtain the information transmitted by the network device to the repeater,
the sixth indication information being a PDCCH, the sixth time unit being one or more time units, and the sixth signal being a PDSCH,
and the sixth signal being used to carry the transmission space filter used by the repeater to transmit the first signal to the network device and/or the reception space filter used by the repeater to receive the second signal.

15. The communication apparatus according to claim 9, wherein,
the transmitter is further configured to transmit seventh indication information to the repeater, the seventh indication information being used to indicate the repeater to receive at a seventh time unit a seventh signal from the network device, the seventh time unit being the flexible time unit and/or the downlink time unit in the TDD uplink and downlink configuration, and the seventh signal being used by the repeater to perform demodulation and decoding to obtain the information transmitted by the network device to the repeater,
the seventh indication information being a PDCCH, the seventh time unit being one or more time units, and the seventh signal being a PDSCH, or, the seventh indication information being higher-layer signaling, the seventh time unit being one or more periodic time units, and the seventh signal being a PDCCH,
and the seventh signal being used to carry a transmission space filter used by the repeater to forward the processed second signal and/or a reception space filter used by the repeater to receive the first received signal.

16. The communication apparatus according to claim 9, wherein the transmitter is further configured to transmit the first indication information to the repeater in a first cell, the first cell being a serving cell of the repeater.
